(19) United States
(12) Patent Application Publication
(10) Pub. No.: US 2015/0064671 A1
(43) Pub. Date: Mar. 5, 2015

(54) METHODS AND SYSTEMS FOR MANAGING GOALS AND PROCESSING GOALS-RELATED DATA

(71) Applicant: Delight Me, Inc., Washington, DC (US)

(72) Inventors: Marie-Louise MURVILLE, Washington, DC (US); Michael SULLIVAN, Herndon, VA (US)

(73) Assignee: Delight Me, Inc., Washington, DC (US)

(21) Appl. No.: 14/471,601

(22) Filed: Aug. 28, 2014

Related U.S. Application Data
(60) Provisional application No. 61/872,156, filed on Aug. 30, 2013.

(51) Int. Cl. G09B 5/00; G06Q 30/02

(52) U.S. Cl. CPC G09B 5/00; G06Q 30/0269; G06Q 30/0207
USPC 434/236

(57) ABSTRACT

Systems, methods and computer readable media for processing user-specified goals can include storing user accounts that are capable of directly linking to another, receiving and storing user-specified goals for each user account and associating proposed accomplishments including a value and unit of measurement, reminders and privacy and security settings. Also included are sending alerts at configurable time periods and providing advertising and rewards in accordance with the user-specified goals. Also included are displaying on a display device the user-specified goal data, progress graphs of user-specified goals for each user account node, and a status of obtaining a reward when a user-specified goal corresponds to one of the goals associated with the rewards.

### CROSS REFERENCE TO RELATED APPLICATIONS

This application claims priority to U.S. Provisional Patent Application No. 61/872,156, filed Aug. 30, 2013, which is hereby incorporated herein by reference in its entirety.

### FIELD

This disclosure relates generally to managing goals, and more particularly to methods, system, and media for managing goals.

### BACKGROUND

This disclosure generally relates to the management of life goals. In order to succeed in today's fast paced complex society, people have to manage many conflicting aspects of their lives. In previous years, people utilized a local support system of family and friends, and paper organizers to receive encouragement and to keep track of their progress. Technology progressed to replace paper tracking and enabled easier communication as people geographically spread out from their core of family and friends. Existing solutions that help people manage their lives deal only with a narrow focus on only one aspect of their lives—school, work, home, hobbies, finances. None provide an integrated way to involve all types of technologies (pcs, smartphones, tablets, wireless meters) and all types of life coaches (family, friends, doctors, coaches, mentors, teachers) in a seamless manner. Additionally, there is a limited to total lack of comprehensive integrated concept of sponsors and rewards to motivate individuals or groups into achieving their goals.

### SUMMARY

In one embodiment, a computer system includes at least one processor for processing user-specified goal data for a plurality of user accounts and includes a user-account storage unit that is configured to store a plurality of user account nodes, each user account node being configured to be directly linked to another of the plurality of user account nodes, and the linked user account nodes being configured using the at least one processor to form one of a plurality of relationships.

The computer system further includes a goal-setting unit that is configured, for each user account node, (1) to receive at least one user-specified goal input from a user, a goal category input associated with the at least one user-specified goal, and at least one inputtable user-specified proposed accomplishment that relates to the user completing the respective goal, the user-specified proposed accomplishments having a value field that can be input by the user and a unit of measurement field that can be input by the user to a plurality of options, and (2) to store the at least one user-specified goal, the associated goal category and the at least one inputtable user-specified proposed accomplishment, as well as actual data related to achieving the proposed accomplishments, in a data storage unit, the goal-setting unit being configured to allow each user-specified goal of a user account node to select at least one of (a) a coach node and (b) at least one buddy node, from a predefined list of connections that are directly linked to the user account node, the selection of the at least one of the coach node and the at least one buddy node forming a relationship between the nodes.

The computer system further includes a reminder-management unit that is configurable to assign user-specified reminders to each proposed accomplishment using the at least one processor, and to send predetermined reminders for the user-specified proposed accomplishments, the reminder-management unit being configured to send alerts at configurable time periods for a user-specified proposed accomplishment of the user account node when the user associated with the user account node has not satisfied the user-specified proposed accomplishment, and the reminder-management unit being configured to store periodic user-input associated with the user achieving the proposed accomplishment in the data storage unit.

The computer system further includes a reward-management unit that includes a plurality of sponsor nodes with associated rewards for completing goals that the plurality of sponsor nodes offer, as well as respective requirements for obtaining the reward. The computer system further includes a messaging unit that is configured to accept input and send the input in a message from a sender user account node to at least one of a plurality of recipient user account nodes, the recipient user account nodes being in a relationship with the sender user account node, the messaging unit being configured to associate the message with one of the goals of the user account node.

The computer system further includes a display device that is configured to display (i) the user-specified goal data, (ii) progress graphs of user-specified goals for each user account node, and (iii) a status of obtaining a reward when a user-specified goal corresponds to one of the goals in the reward-management unit, the display device analyzing the actual value data of the data storage unit, wherein the goal-setting unit is configured to associate each user-specified goal with the user account node or with another node or group of nodes that is in a relationship with the user account node, and wherein the goal-setting unit is configured by the user to change one of a plurality of privacy settings in relation to the coach node and the buddy node, and to change one of a plurality of privacy settings in relation to the user-specified goals.

In another embodiment, a non-transitory computer readable storage medium for processing user-specified goal data for a plurality of user accounts using at least one processor, the computer readable storage medium storing instructions that, when executed, cause a computer to perform steps of storing a plurality of user account nodes in a data storage unit, each user account node being configured to be directly linked to another of the plurality of user account nodes, and linked user account nodes being configured to form one of a plurality of relationships; receiving for each user account node at least one user-specified goal input from a user, a goal category input associated with the at least one user-specified goal, and at least one inputtable user-specified proposed accomplishment that relates to the user completing the respective goal, the user-specified proposed accomplishments having a value field that can be input by the user and a unit of measurement field that can be input by the user to a plurality of options, whereby each user-specified goal of a user account node is configured to select at least one of (a) a coach node and (b) at least one buddy node, from a predefined list of connections that are directly linked to the user account node, the selection of the at least one of the coach node and the at least one buddy node forming a relationship between the nodes; storing in the data storage unit the at least one user-specified goal with the associated goal category and the at least one inputtable user-specified proposed accomplishment, and the corresponding relationship between the nodes; assigning user-specified reminders to each proposed accomplishment and send predetermined reminders for the user-specified proposed accomplishments; sending alerts at configurable time periods for a user-specified proposed accomplishment of the user account node when the user associated with the user account node has not satisfied the user-specified proposed accomplishment; providing a plurality of sponsor nodes with associated rewards for completing goals that the plurality of sponsor nodes offer, as well as respective requirements for obtaining the reward; accepting input and sending the input in a message from a sender user account node to at least one of a plurality of recipient user account nodes based on predetermined user input, the recipient user account nodes being in a relationship with the sender user account node, the message being configured to associate with one of the goals of the user account node; displaying on a display device (i) the user-specified goal data, (ii) progress graphs of user-specified goals for each user account node, and (iii) a status of obtaining a reward when a user-specified goal corresponds to one of the goals associated with the rewards; associating each user-specified goal with the user account node or with another node or group of nodes that is in a relationship with the user account node; and prompting the user to select for each user-specified goal one of a plurality of privacy settings in relation to the coach node and the buddy node, and to change one of a plurality of privacy settings in relation to the user-specified goals.

In another embodiment, a computer-implemented method for processing user-specified goal data for a plurality of user accounts using at least one processor, the computer-implemented method including storing a plurality of user account nodes in a data storage unit, each user account node being configured to be directly linked to another of the plurality of user account nodes, and linked user account nodes being configured to form one of a plurality of relationships; receiving for each user account node at least one user-specified goal input from a user, a goal category input associated with the at least one user-specified goal, and at least one inputtable user-specified proposed accomplishment that relates to the user completing the respective goal, the user-specified proposed accomplishments having a value field that can be input by the user and a unit of measurement field that can be input by the user to a plurality of options, whereby each user-specified goal of a user account node is configured to select at least one of (a) a coach node and (b) at least one buddy node, from a predefined list of connections that are directly linked to the user account node, the selection of the at least one of the coach node and the at least one buddy node forming a relationship between the nodes; storing in the data storage unit the at least one user-specified goal with the associated goal category and the at least one inputtable user-specified proposed accomplishment, and the corresponding relationship between the nodes; assigning user-specified reminders to each proposed accomplishment and send predetermined reminders for the user-specified proposed accomplishments; sending alerts at configurable time periods for a user-specified proposed accomplishment of the user account node when the user associated with the user account node has not satisfied the user-specified proposed accomplishment; providing a plurality of sponsor nodes with associated rewards for completing goals that the plurality of sponsor nodes offer, as well as respective requirements for obtaining the reward; accepting input and sending the input in a message from a sender user account node to at least one of a plurality of recipient user account nodes based on predetermined user input, the recipient user account nodes being in a relationship with the sender user account node, the message being configured to associate with one of the goals of the user account node; displaying on a display device (i) the user-specified goal data, (ii) progress graphs of user-specified goals for each user account node, and (iii) a status of obtaining a reward when a user-specified goal corresponds to one of the goals associated with the rewards; associating each user-specified goal with the user account node or with another node or group of nodes that is in a relationship with the user account node; and prompting the user to select for each user-specified goal one of a plurality of privacy settings in relation to the coach node and the buddy node, and to change one of a plurality of privacy settings in relation to the user-specified goals.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

Embodiments will now be described in connection with the associated drawings, in which:

FIG. 1 depicts a block diagram of an exemplary system 100 in accordance with one or more embodiments.

FIG. 2 depicts an exemplary flow diagram for creating and managing accounts in accordance with one or more embodiments.

FIG. 3 depicts an exemplary interface 300 for inviting users to the service in accordance with one or more embodiments.

FIG. 4 depicts an exemplary interface 400 for viewing incoming invitations in accordance with one or more embodiments.

FIG. 5 depicts an exemplary interface 500 for viewing outgoing invitations in accordance with one or more embodiments.

FIG. 6 depicts an exemplary interface 600 for managing account settings in accordance with one or more embodiments.

FIG. 7 depicts an exemplary interface 700 for viewing a service user's profile in accordance with one or more embodiments.

FIG. 8 depicts an exemplary interface 800 for editing a user profile in accordance with one or more embodiments.

FIG. 9 depicts an exemplary interface 900 for editing medical information in accordance with one or more embodiments.

FIG. 10 depicts an exemplary interface 1000 for editing user account settings in accordance with one or more embodiments.

FIG. 11 depicts an exemplary interface 1100 for displaying dashboard settings as well as various categories in accordance with one or more embodiments

FIG. 12 depicts an exemplary interface 1200 for managing groups in accordance with one or more embodiments.

FIG. 13 depicts an exemplary interface 1300 for presenting group progress in accordance with one or more embodiments.

FIG. 14 depicts an exemplary interface 1400 for managing goals in accordance with one or more embodiments.

FIG. 15 depicts an exemplary coach or delighter interface 1500 in accordance with one or more embodiments.

FIG. 16 depicts an exemplary dashboard interface 1600 in accordance with one or more embodiments.

FIG. 17 depicts an exemplary dashboard interface 1700 in accordance with one or more embodiments.

FIG. 18 depicts an exemplary alternate interface 1800 showing buddies in accordance with one or more embodiments.

FIG. 19 depicts an exemplary my network interface 1900 in accordance with one or more embodiments.

FIG. 20 depicts an exemplary interface 2000 for adding a new goal or editing a goal in accordance with one or more embodiments.

FIG. 21 depicts an exemplary interface 2100 for adding a new goal or editing a goal in accordance with one or more embodiments.

FIG. 22 depicts an exemplary interface 2200 for adding a new goal or editing a goal in accordance with one or more embodiments.

FIG. 23 depicts an exemplary interface 2300 for reviewing a goal in accordance with one or more embodiments.

FIG. 24 depicts an exemplary interface 2400 for viewing messages in accordance with one or more embodiments.

FIG. 25 depicts an exemplary alternate interface 2500 for viewing messages in accordance with one or more embodiments.

FIG. 26 depicts an exemplary interface 2600 for composing a message in accordance with one or more embodiments.

FIG. 27 depicts an exemplary interface 2700 for viewing a can-do in accordance with one or more embodiments.

FIG. 28 depicts exemplary interfaces 2810, 2820, and 2830 for entering information in accordance with one or more embodiments.

FIG. 29 depicts exemplary interfaces 2910 and 2920 for entering information in accordance with one or more embodiments.

FIG. 30 depicts an exemplary interface 3000 for displaying progress graphs in accordance with one or more embodiments.

FIG. 31 depicts an exemplary interface 3100 for displaying progress graphs in accordance with one or more embodiments.

FIG. 32 depicts an exemplary branding/sponsor template 3200 in accordance with one or more embodiments.

FIG. 33 depicts an exemplary architecture for implementing a computing device 3300 in accordance with one or more embodiments.

### DETAILED DESCRIPTION OF THE DRAWINGS

Exemplary embodiments are discussed in detail below. While specific exemplary embodiments are discussed, it should be understood that this is done for illustration purposes only. In describing and illustrating the exemplary embodiments, specific terminology is employed for the sake of clarity. However, the embodiments are not intended to be limited to the specific terminology so selected. A person skilled in the relevant art will recognize that other components and configurations may be used without parting from the spirit and scope of the embodiments. It is to be understood that each specific element includes all technical equivalents that operate in a similar manner to accomplish a similar purpose. The examples and embodiments described herein are non-limiting examples.

A service, e.g., the Delight Me® (DM) service, may be an online service that is accessible by any computing device with a web browser or a custom application, e.g., a Delight Me® custom application. The service may be provided by a service provider, e.g., Delight Me®, using a system, e.g., the DM system, which may comprise software and servers that enable the functionality of the service. A user, e.g., a DM User, may be a person who has an account with the service, e.g., a Delight Me® account, that creates and/or monitors progress on their own goals. A user may also be a coach if the user has created and/or assigned a goal to another user or has been invited to help achieve a goal from another user. The coach can be referred to as a delighter coach. A user may simultaneously be a delightee user if they have been assigned a goal from another user. A delightee user may refer to a person who has a user account and has been assigned a goal by another user or by themselves. A coach or delighter coach may refer to a user who can create, review, update, delete, and/or assign goals to other users. The terms coach and delighter may be used interchangeably.

The service may provide several functions, which may be presented in web pages or application screens. The service may provide a Dashboard, a Network (e.g., My Network), Progress, Goals, Proposed Accomplishments (or Can-dos), Messages, Groups, and Content/Advertising to one or more users. A Dashboard may provide a view of a user's personal goals; a view from a coach's perspective of how the users they are coaching are progressing, or a view of other users' (Buddies) progress. A delightee's dashboard may display a view of the delightee's current day reminders, recent messages, and graphical progress on some of their goals. A coach's/delighter's dashboard may display a view of the coach's/delighter's delightees, i.e., users they are helping achieve their goals, their recent data entry values, and the most recent messages between the coach and delightee. A Buddies dashboard may display a view of the progress of other users that have requested moral support but they are not a coach.

In some embodiments, a service, e.g., Delight Me, allows for statistical analysis of quantitative and qualitative characteristics of human traits data by aggregating data in various categories of behavior. The humans traits data can be used to track and test hypotheses based on data entered about an individual or a group of individual's behavior. The service can use the human traits data that can be entered in relation to goals or can-dos, or data that is entered or kept track of independent of particular goals or can-dos.

The term “goal” is intended to have a broad meaning that may be used as objectives of human, human-related or non-human performance and/or behavior or data measurement in various fields or categories. The term “can-do” or “proposed accomplishment” is intended to have a broad meaning that may be used as a more definite objective than a goal and that can be used as a building block to a goal. The term “buddy” is intended to have a broad meaning that may be used as an account node that is linked to a user account. In one embodiment, the buddy can be configured to message the user account to provide the user account with support and encouragement.

A Network, e.g., a My Network Page, may provide a list of users in which the user has established a relationship, e.g., as a friend, delighter, or delightee. The Network may contain a list of DM users that the current user has set up a relationship with. This relationship enables them to access other features related to communicating or monitoring the progress of the user thru the DM system. This interface enables the user to invite other DM and external users into their DM network.

Progress may provide a view of the progress of the user or other users in achieving their goals.

Goals, e.g., a Goals Page or Module, may provide a view of the goals that the user is trying to achieve as well as a view into the goals of others the user is coaching. The Goals page may enable the user to view, create, review, update and delete goals related to the user. New goals may be defined or modified in this interface. Coaches/delighters may define goals for other users. If a coach or delighter sets a goal for a user, then only the coach and user may see that goal, unless otherwise specified. A user may allow others to see the user's goals if they are invited as a buddy. A default setting may be that goals are private until they are shared. Goals may be shared on a goal-by-goal basis. Once a user shares goals, all of the proposed accomplishments or can-dos and data entered with the can-dos may be shared as well.

When creating a goal, a user may assign it to oneself or to another DM user or group. The assigned user may be reminded to enter data at specified intervals so that the DM system can track progress towards the goal. The Coach and User can view progress of the goal via the DM interface. Upon completion of a goal, the user can archive or delete the data collected for the goal. Archived data may be stored in an archive online Goals, Can Do's, and data may have many states, including pending, active, archived, deleted, etc. Goals, Can Do's, and data may also be exported into other formats, e.g., Excel, Word, PDF, etc.

Can-dos, e.g., Can-dos page or Module, may provide a view into the daily tasks or habits a user must perform and then record data on the actions taken related to the task. This page may show a list of the can-do items (e.g., tasks or habits) on a specific day (past, current or future) and time or times, and allows the user to enter or edit data related to each Can-Do item. The data entered goes into a database which enables the DM system to generate graphics showing progress toward a goal. Can-dos can also accept annotations and files (documents, video, audio, photo) to provide additional information and context.

Messages, e.g., Messages page or Module, may provide a view into the internal messages sent and/or received between service users. Messages page may enable DM users to send and receive private or group messages to other users or groups in their network. The user can select whether to have the DM system send an external email; text message or social media message to the recipient notifying them of a DM message.

Groups, e.g., Groups page or Module, may provide a view into the creation and monitoring of groups of service users and their goals and progress. Groups may enable a DM user to create, review, update and delete groups of DM users which makes it possible for them to assign goals, track progress and send messages to multiple DM users at a time. Thus, the computer system 100 can include a group management unit that is configurable to assign a plurality of user account nodes to a group and is configurable to create member-specified group goals. In one embodiment, each member of the group can add, edit and delete the member-specified group goals. Further, in an embodiment, the display device can show group progress of the member-specified group goals.

Content, e.g., Content page or Module, may provide an interface provided to service advertisers that enables them to setup advertising campaigns to a subset of service users based on service provided user information and activity.

Other types of users may also exist. For example, an administrator may be a user that is provided with functionality to create users and assign enterprise goals. The administrator may interact with the computer system 100 just as a normal user would, but the administrator may have a super-set of privileges and/or features.

After a user establishes the user's account, the user can, among other things, create personal goals and create a network of friends and coaches on the service. Friends and coaches will create additional goals for the user to help them in different aspects of their life. On a daily basis, the user may be reminded via email and/or text messages of tasks and habits they need to accomplish their goals. Also daily, the user may login to enter data related to their tasks and habits so that they can track their progress and send and receive messages from their network of coaches and friends.

The user can setup email and text reminders for the computer system 100 to send them to remind them of the daily tasks and data entry they need to do so they can achieve their goals. The initial tasks may be setting up the goals and defining the reminder methods and intervals, and their daily tasks are entering data on how they are progressing toward their goals. As discussed above, daily goals and can-dos reminder may be emailed to the user at the beginning of a day. In other embodiments, a user may set time for when a Can-do can be done, and then receive a reminder at that time.

The users of the service may access the service via a web browser on any device that supports a browser and an internet connection or via an application built specifically for a user device. The service may provide one or more online interfaces, e.g., pages, screens, application interfaces, etc., like those discussed above, to users of users devices.

Information captured by the computer system 100 may be used to generate one or more reports. For example, goals may be analyzed across people, e.g., a sports team. In a financial advisor example, sales success may be analyzed, for example. Since the goal data for one or more users is stored in the database, users can do whatever they want with the data. Customized data reports may be created for particular interests.

The service may be used to present advertising to one or more users. Advertising may be delivered to users based on information collected from the computer system 100, e.g., generic profile information such as a zip code, a user's interests such as those specified by the user as a category of interest, a type of public and/or sponsored goal that the user has selected, and/or previous navigation or click activity by the user. When a user creates a goal, the user may categorize the goal, which may be used as a basis for delivering advertising to a user.

Advertising matching an advertiser's target audience or profile may be delivered to users. The computer system 100 may determine what advertising to deliver based on the advertiser's targeting criteria. The advertiser defines criteria on what type of user should receive its ads and the computer system 100 matches the user to the advertiser. The service may internally have advertising content as well as use references to external content for delivering advertising to the user. For example, advertising content may come from servers or from external sources, like third party advertising serving systems. The same applies for applications, which may have data stored on the device or in the application, on the service's servers, or on third party servers.

The advertiser determines who to target, and then the computer system 100 determines when to target. The service may provide generic (broadcast) advertisements as well. Advertisements will appear in the webpages and in the application interfaces that the user sees when using the computer system 100 from any type of network connected device. Advertisers may also sponsor goals so that their advertisements might appear with the goal activity.

Users may also earn rewards for participating in and/or completing sponsored goals. Advertisers may sponsor a goal, e.g., exercise 20 min a day for 3 months straight. Then, for people that follow through, they get a certificate for free merchandise, discounts, and/or any other type of reward. Thus, the computer system 100 can include an advertising unit that manages and displays advertising data for the user.

The service may be used for a range of goals or applications. For example, users may input goals related to their health. In one or more embodiments, the service may be used to manage financial goals and information. For example, users may define goals that gather financial information. The type of information gathered may be under the user's control. A user may share the information with a financial advisor. Any correspondence a financial advisor makes may be under their control, and the content may be under the user's control. Thus, each user can control who can see the correspondence sent to another user just like email. The financial advisor may work as a coach or delighter, and may setup, monitor, and help manage a user's financial goals. The computer system may allow a financial advisor to provide online ads to the computer system 100 users. Targeting these ads will be based on information provided by users when they sign up for the computer system 100 and if the user accepts goals sponsored by specific advertisers. The financial advisor may also operate as an administrator and setup accounts for their clients to use as users of the service.

Although the embodiments described herein may refer to Delight Me®, the DM service, or the DM users, it should be understood that any features discussed with respect to these embodiments may apply more generally to any service provider, service, system, or users, unless otherwise specified.

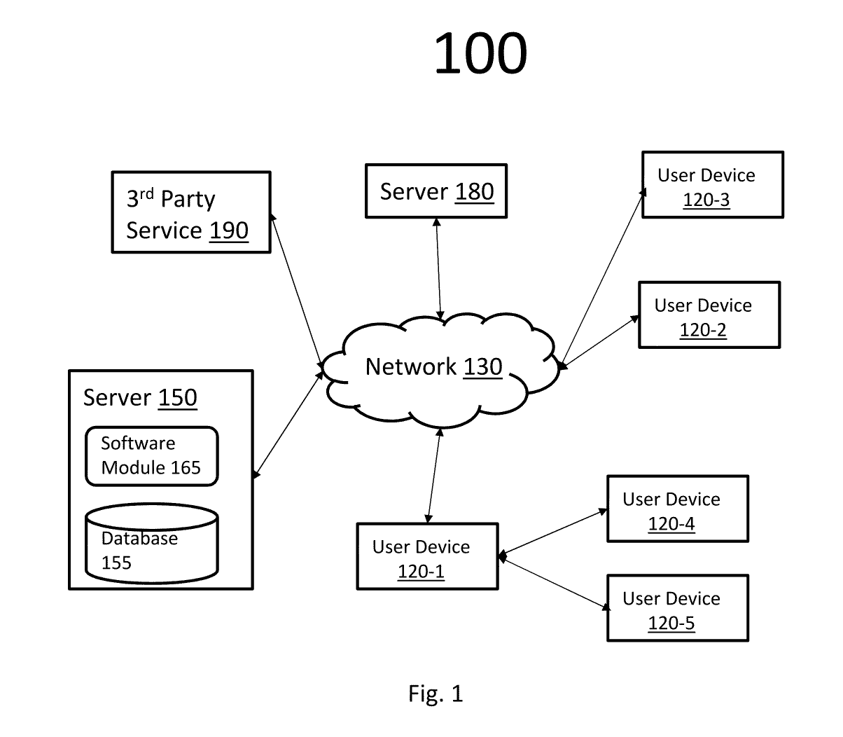

FIG. 1 depicts a block diagram of an exemplary computer system 100 in accordance with one or more embodiments. In FIG. 1, a computer system 100 includes at least one processor for processing user-specified goal data for a plurality of user accounts. The user accounts can be accessible by user device 120-1, 120-2, 120-3, 120-4, 120-5. The computer system 100 can include a user-account storage unit that is configured to store a plurality of user account nodes, each user account node being configured to be directly linked to another of the plurality of user account nodes, and the linked user account nodes being configured using the at least one processor to form one of a plurality of relationships.

The computer system 100 can also include a goal-setting unit that is configured, for each user account node, to receive at least one user-specified goal input from a user. In one embodiment, the user-specified goal input can be received from the user directly from user device 120-2, 120-3. In another embodiment, the user-specified goal input can be received by user device 120-4, 120-5 through an intermediary user-device 120-1. In addition to the user-specified goal input, the goal-setting unit can be configured to receive a goal category input associated with the at least one user-specified goal. In one embodiment, goal categories can be selected from a predefined list of categories. For example, the goal categories list can include 9 categories: sports, career, health, school, money, diet, family, world, and hobbies. However, the categories can also be user-specified and can be more or less than 9 total. Additionally, the goal-setting unit can be configured to receive at least one inputtable user-specified proposed accomplishment (or can-do) that relates to the user completing the respective goal. In one embodiment, the user-specified proposed accomplishments can have a value field that can be input by the user to be any value. The user-specified proposed accomplishment can also have a unit of measurement field that can be input by the user to a plurality of options.

The goal-setting unit can be configured, for each user account node, to store the at least one user-specified goal and the associated goal category and the associated at least one inputtable user-specified proposed accomplishment in a data storage unit. The data storage unit can include a database 155 that is accessible to the network 130. Database 155 may be any type of database, including a database managed by a database management system (DBMS). A DBMS is typically implemented as an engine that controls organization, storage, management, and retrieval of data in a database. DBMSs frequently provide the ability to query, backup and replicate, enforce rules, provide security, do computation, perform change and access logging, and automate optimization. Examples of DBMSs include Oracle database, IBM DB2, Adaptive Server Enterprise, FileMaker, Microsoft Access, Microsoft SQL Server, MySQL, PostgreSQL, and a NoSQL implementation. A DBMS typically includes a modeling language, data structure, database query language, and transaction mechanism. The modeling language is used to define the schema of each database in the DBMS, according to the database model, which may include a hierarchical model, network model, relational model, object model, or some other applicable known or convenient organization. Data structures can include fields, records, files, objects, and any other applicable known or convenient structures for storing data. A DBMS may also include metadata about the data that is stored.

The computer system 100 can include a reminder-management unit that can be configurable to assign user-specified reminders to each proposed accomplishment using the at least one processor. The reminder-management unit can also configured to send predetermined reminders for the user-specified proposed accomplishments. The reminder-management unit can be configured to send alerts at configurable time periods for a user-specified proposed accomplishment of the user account node when the user associated with the user account node has not satisfied the user-specified proposed accomplishment.

The computer system 100 can include a reward-management unit that includes a plurality of sponsor nodes with associated rewards for completing goals that the plurality of sponsor nodes offer, as well as respective requirements for obtaining the reward.

The computer system 100 can include a display device that is configured to display the user-specified goal data. In one embodiment, the goal-setting unit can be configured by the user to change one of a plurality of privacy settings such that the goals can be displayed to the user according to a certain set of privacy settings. In an embodiment, the display device can be configured to display progress graphs of user-specified goals for each user account node. The display device can be configured to also display a status of obtaining a reward when a user-specified goal corresponds to one of the goals in the reward-management unit.

In one embodiment, the goal-setting unit can be configured to allow each user-specified goal of a user account node to select a coach node and can be configured to allow each user-specified goal of a user account node to select at least one buddy node from a predefined list of connections that are directly linked to the user account node. The coach node and at least one buddy node can also be directly linked to the user account node upon acceptance of an invitation to be linked. That is, upon acceptance of an invitation to join, the coach node and the at least one buddy node can be linked to the user account. The selection of the coach node or the selection of at least one buddy node can form a relationship between the user node and the coach node and/or at least one buddy nodes. In one embodiment, the goal-setting unit can be configured by the user to change one of a plurality of privacy settings in relation to the user-specified goals.

System 100 may include one or more user devices, e.g., user device 120-1, user device 120-2, user device 120-3, user device 120-4, and user device 120-5, network 130, server 150, database 155, software module 165, and server 180. System 100 may also include connections to 3rd party services which deliver and receive various data to the DM system.

The one or more user devices, e.g., user device 120-1, user device 120-2, user device 120-3, user device 120-4, and user device 120-5 may be any type of computing device, including a mobile telephone, a laptop, tablet, or desktop computer having, a netbook, a video game device, a pager, a smart phone, an ultra-mobile personal computer (UMPC), a personal data assistant (PDA), or a metering device, e.g., a blood pressure monitor, scale, heart rate monitor, recording device (audio, video, telemetry), etc. The one or more user devices may run one or more applications, such as Internet browsers, voice calls, video games, videoconferencing, text messaging, and email, among others. The one or more user devices may be any combination of computing devices. These devices may be coupled to network 130. The one or more user device may be in communication with each other. For example, user device 120-1 may be a personal computer that is used to retrieve, display and send data to one or more other portions of system 100, e.g., server 150 or server 180. User device 120-2 may be a tablet that transmits the blood pressure information to one or more other portions of system 100, e.g., server 150 or server 180. One or more of the devices may communicate to the server through one or more other devices. User devices 120-4 and 120-5 may communicate through user device 120-1. For example, user device 120-1 may be a smartphone, and 120-4 may be a blood pressure monitoring device that communicates with user device 120-1 using Bluetooth. The smartphone may receive information from the blood pressure monitoring device and communicate that information to one or more other portions of system 100, e.g., server 150 or server 180. One or more device may include applications that accept audio input and converts audio to data sent to the servers. For example, user device 120-1 may be a smartphone with an input, e.g., a microphone, that may receive speech from the user. The user may speak information tracked by the computer system 100, e.g., a weight for the day, and an application on the smartphone may convert that into a data value, e.g., a numerical value, that may be sent to the server. The conversion of audio to data may be performed on any device or server used in the computer system 100.

Network 130 may provide network access, data transport and other services to the devices coupled to it. In general, network 130 may include and implement any commonly defined network architectures including those defined by standards bodies, such as the Global System for Mobile communication (GSM) Association, the Internet Engineering Task Force (IETF), and the Worldwide Interoperability for Microwave Access (WiMAX) forum. For example, network 130 may implement one or more of a GSM architecture, a General Packet Radio Service (GPRS) architecture, a Universal Mobile Telecommunications System (UMTS) architecture, and an evolution of UMTS referred to as Long Term Evolution (LTE). Network 130 may, again as an alternative or in conjunction with one or more of the above, implement a WiMAX architecture defined by the WiMAX forum. Network 130 may also comprise, for instance, a local area network (LAN), a wide area network (WAN), the Internet, a virtual LAN (VLAN), an enterprise LAN, a layer 3 virtual private network (VPN), an enterprise IP network, or any combination thereof.

Server 150 or server 180 may also be any type of computing device coupled to network 130, including but not limited to a personal computer, a server computer, a series of server computers, a mini computer, and a mainframe computer, or combinations thereof. Server 150 or server 180 may be a web server (or a series of servers) running a network operating system, examples of which may include but are not limited to Microsoft Windows Server, Novell NetWare, Mac OS, Unix, or Linux. Server 150 or server 180 may be used for and/or provide cloud and/or network computing. For example, multiple cloud providers—one to host the application, one to deliver email, and one to log data—can be implemented. Server 150 and or server 180 and or Service 190 may have connections to external systems like email, SMS messaging, text messaging, ad content providers, etc. Any of the features of server 150 may be also implemented in server 180 and vice versa.

Software module 165 may be a module that is configured to send, process, and receive information at server 150. Software module 165 may provide another mechanism for sending and receiving data at server 150 besides handling requests through web server functionalities. Software module 165 may send and receive information using any technique for sending and receiving information between processes or devices including but not limited to using a scripting language, a remote procedure call, an email, a tweet, an application programming interface, Simple Object Access Protocol (SOAP) methods, Common Object Request Broker Architecture (CORBA), HTTP (Hypertext Transfer Protocol), REST (Representational State Transfer), JSON (JavaScript Object Notation), any interface for software components to communicate with each other, using any other known technique for sending information from a one device to another, or any combination thereof.

Although software module 165 may be described in relation to server 150, software module 165 may reside on any other device. Further, the functionality of software module 165 may be duplicated on, distributed across, and/or performed by one or more other devices, either in whole or in part.

For example, the service, e.g., a DM service, may leverage Web 2.0 and open source technologies, including the entire LAMPS stack (Linux, Apache, MySQL database, PHP, Scripting), to implement its service on an architecture, e.g., on the computer system 100 depicted in FIG. 1. The service may implement a multi-tiered architecture supported by a scalable infrastructure. Customer data may be encrypted and held in secure databases. Smartphone and tablet implementations of the service may be built with free development tools provided by mobile OS vendors. A service provider, e.g., Delight Me®, may partner with a Tier 1 data processing and hosting services provider to manage the operation of its platform.

People Management

In one embodiment, a computer-implemented method can use a data structure designed to organize and process user-specified goal data for a plurality of user accounts. The data elements of each user account and user-specified goal data using the data structure can be linked together in ways that provide multiple types of relationships between users of the system such as coach to delightee, delightee to coach, delightee to delightee, buddy to delightee, coach to coach.

The data structure can include a user-account storage unit configured to store a plurality of user account nodes, each user account node capable of being directly linked to another of the plurality of user account nodes, linked user account nodes being configured to form a plurality of relationships. The data structure can include a goal-setting unit configured to store at least one user-specified goal among a plurality of categories for each user account node, each user-specified goal including at least one inputtable user-specified proposed accomplishment that relates to the user completing the respective goal, the user-specified proposed accomplishments having a value field that can be input by the user and a unit of measurement field that can be input by the user to a plurality of options. The data structure can include a reminder-management unit that is configurable to assign user-specified reminders to each proposed accomplishment and send predetermined reminders for the user-specified proposed accomplishments, the reminder-management unit being configured to send alerts at configurable time periods for a user-specified proposed accomplishment of the user account node when the user associated with the user account node has not satisfied the user-specified proposed accomplishment. The data structure can also include a reward-management unit that includes a plurality of sponsors organized by category that offer rewards for completing goals, as well as respective requirements for obtaining the reward.

In one embodiment, the computer-implemented method prompts a user to select for each user-specified goal of a user account node at least one of (a) a coach and (b) at least one buddy, from a predefined list of connections that are directly linked to the user account node or can be directly linked to the user account node upon acceptance of an invitation to be directly linked. The goal-setting unit can be configured to allow each goal to have (i) one of a plurality of privacy settings in relation to the coach and buddy that is configurable by the user, and (ii) one of a plurality of privacy settings in relation to the user-specified goals. The display device can be configured to display progress graphs of user-specified goals for each user account node and to show a status of obtaining a reward when a user-specified goal corresponds to one of the goals in the reward-management unit.

### Creating and Managing Accounts

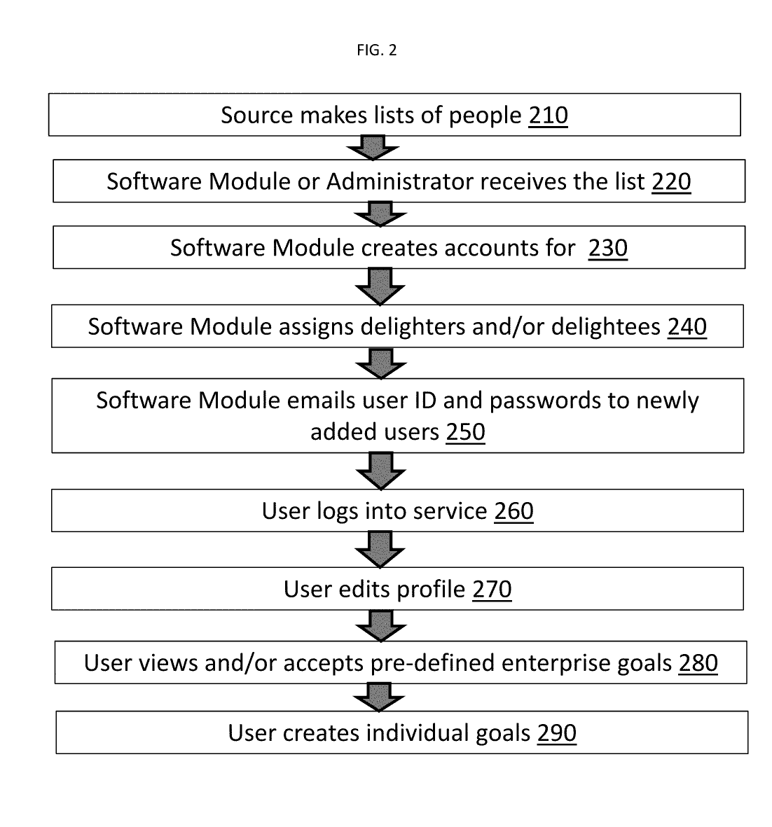

Creating and managing accounts may be performed in several different ways. FIG. 2 depicts an exemplary flow diagram for creating and managing accounts in accordance with one or more embodiments. In block 210, a source may create a list of people for which accounts are to be created. A source may be a company, an administrator, a user, a school, a coach, a doctor, a teacher, a financial advisor, a club, an association, etc. The list may include information for people on the list, including names, email addresses, addresses, delighter and/or delightee relationships, title, profession, certifications, degrees, specialties, class (e.g., 2013 or math class), or any combination thereof. For example, a source may create a list of 10-100 people. In block 220, a software module 165 or an administrator may receive the list from the source. If an administrator receives the list, the administrator may transmit or enter the list into software module 165. In block 230, software module 165 may create accounts for each person identified on the list. In block 240, after or during account creation, software module 165 may assign delighters and delightees. In block 250, software module 165 may email each user of a newly created account a user identifier and a password. In block 260, a user may log into the service using the user identifier and password. In block 270, a user may edit the user's profile, e.g., by editing public profile information, private profile information, photos, and/or graphics. All, portions, or none of the information associated with a user may or may not be visible to other users of the computer system 100 via the user's profile. In block 280, a user may view and/or accept pre-defined enterprise goals. Pre-Defined enterprise goals may come from either a DM person creating a goal based on specifications from the enterprise administrator, or the enterprise administrator may create template goals/can-dos which users in the enterprise can select from or be assigned to by the administrator or other enterprise user. In block 290, a user may create individual goals.

### Inviting People

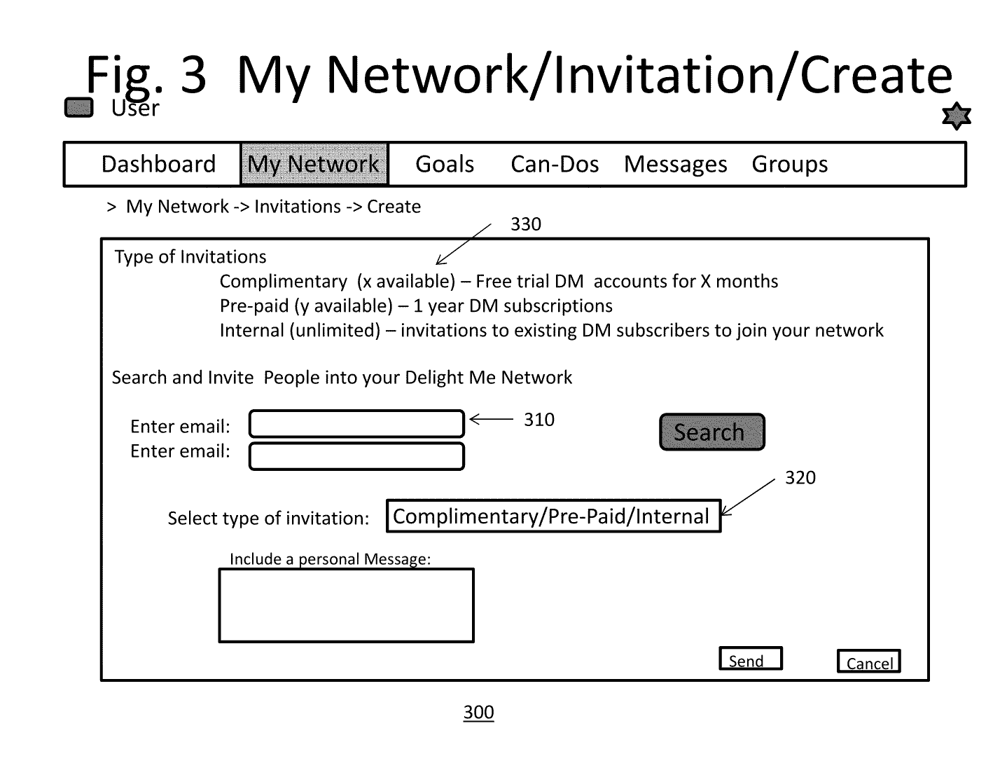

A user may invite others into the user's network, regardless of whether the other person is already a user of the service or is not. FIG. 3 depicts an exemplary interface 300 for inviting users to the service in accordance with one or more embodiments. For FIGS. 3-32, the Figures can be a representation of an interface on a stationary computer display or a laptop display. However, as one skilled in the art would appreciate, the interface can also be modified to fit a mobile device in a somewhat more simplified manner. In FIG. 3, interface 300 may allow a user to input one or more email addresses in multiple data entry fields 310 and search to see if those emails already have a Delight Me® account. Email addresses that already have a Delight Me® account will receive an Internal invitation. Non-members can receive different types of invitation as selected using drop down list 320.

Interface 300 may allow a user to invite users external to the service to the service and to the user's network. The user has different types of invitations to select from when inviting additional user to their network. The type of invitations and the quantities available will be shown to the user depicted in field 330. Some example types of invitations are as follows. Internal invitations are for users that already have Delight Me® accounts. Complimentary invitations are to non-existent Delight Me® subscribers and entitles them to a free subscription trial period. Pre-paid subscriptions entitle the recipient to typically a free one year subscription. Although interface 300 depicts fields to enter the information for two users, the number of users that may concurrently be invited from the same interface is not limited to two and may be three, four, or any number of fields that may be accommodated by an interface. Interface 300 may perform email formatting check on information entered into any of the email address fields. In some embodiments, interface 300 may provide the ability for a user to select contact address book, such as Outlook, Mac Contacts, etc., and select a user whose contact information would populate the email field, thereby saving the user time on data entry. The user may also enter a message into the message field which may be transmitted with the invitation to the invitee.

Once the user has searched for one or more invitees using interface 300 and selected the invitation type in the drop down list 320, the user may make a selection, e.g., clicking the send button, to request that the invitation(s) be sent. After the request is made, interface 300 may display a pop-up window displaying the status of the invitation(s), e.g., that the invitation(s) were sent; generate any error messages, or any combination thereof. Once the request is received by software module 165, software module 165 may check database 155 to determine if any invitees are already of the type selected in the request (e.g., delighter/ee/Friend) and if so, generate message that they (e.g., showing First/Last Name) will not be sent an invite. Software module 165 may also generate messages to selected DM users (e.g., in the format From: FIRST_LAST_NAME To: Service User) that they have been invited to be part of the user's Network. External users may be sent an email message and any error status may be shown on the Outgoing Invite screen. Software module 165 may also place a record in the Outgoing Invitation list.

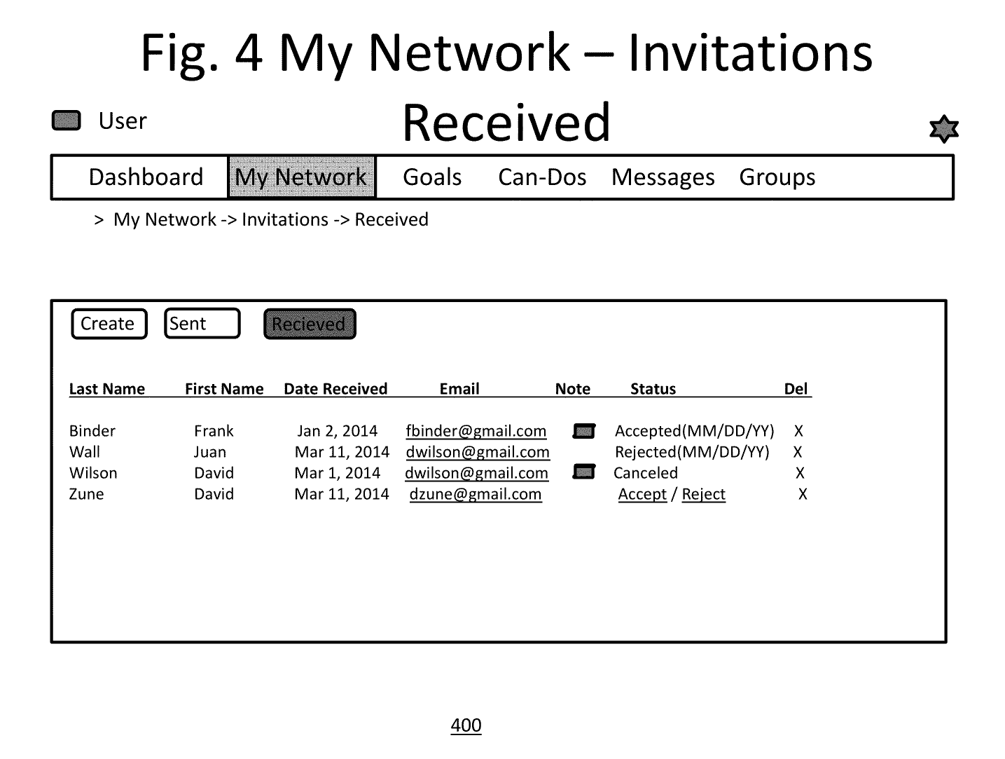

FIG. 4 depicts an exemplary interface 400 for viewing received invitations in accordance with one or more embodiments. Interface 400 may display one or more incoming invitations from users of the service. For each pending invitation, one or more current status indications may be displayed if the inviter is already a user in the invitee's network. A user may be able to select an invitation, e.g., by clicking on it. In response to the selection, interface 400 may display a pop-up display of the inviter's viewable profile and photo. A close button may be present in the window to close the pop-up.

For each pending invitation, interface 400 may present one or more options for handling the invitation. A user may accept an invitation by selecting accept, e.g., by clicking on accept. After the user selects accept, interface 500 may display a popup that acknowledges that the user has been added to the invitee's network, and the invitation may be deleted from interface 400 or the invitation may be left for historical reference. Software module 165 may generate a message from the service either one of or both the user and the inviter that the invitation was accepted. Software module 165 may add the user to the network of the inviter. Software module 165 may also update the Outgoing Invitation status of the inviter. A user may also reject an invitation by selecting reject, e.g., by clicking on reject. After the user selects reject, interface 400 may display a popup that asks the user to confirm the rejection, an open text field for text entry (e.g., an 80 character limited text entry), a send button, and a cancel button. The user may cancel the rejection by selecting the cancel button. The user may confirm the rejection by selecting the send button, and any text entered into the open text field may be transmitted to software module 165. Software module 165 may update the inviter's Outgoing Invitation status to “rejected” with a reason, such as the text entered into the open text field, and may update interface 400 to remove the invitation request.

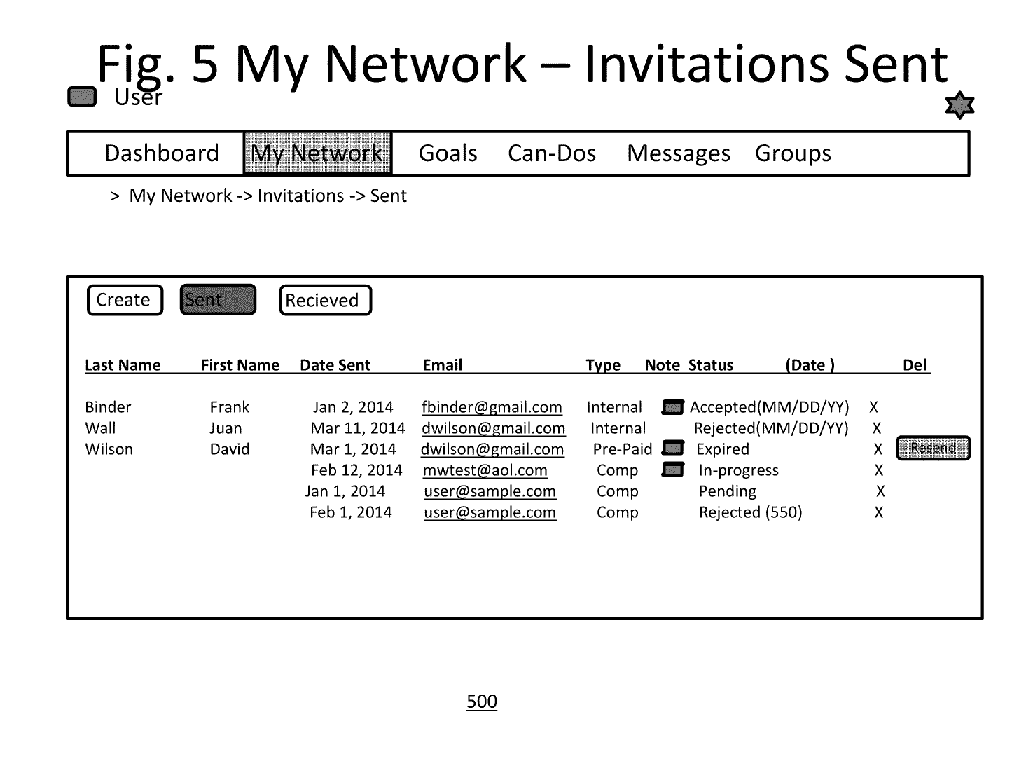

FIG. 5 depicts an exemplary interface 500 for viewing outgoing invitations in accordance with one or more embodiments. Interface 500 may display one or more outgoing invitations from users of the service. For each pending invitation, one or more current status indications may be displayed if the invitee is already a user in the inviter's network. Interface 500 may also display the number of attempts to invite the invitee, e.g., by displaying the number of attempts. Status indications may be represented visually using any shape or color. A user may be able to select an invitation, e.g., by clicking on it. In response to the selection, interface 500 may display a pop-up display of the invitee's viewable profile and photo for an existing DM user. For example, the pop-up may show the invitee's photo, first name, last name, city, state, or any combination thereof. A close button may be present in the window to close the pop-up.

For each pending invitation, interface 500 may present one or more options for handling the invitation. A user may resend the invitation by selecting resend, e.g., by clicking on resend. After the user selects resend, interface 500 may update the date sent field and the number of attempts. The computer system 100, e.g., by using software module 165, may update the date on the Incoming Invitation displayed to the Invitee if an existing user. If the invitee is an external user, software module 165 may resend an invitation email to the invitee. Software module 165 may also generate and send a message through the service that the invitation was resent. A user may edit the invitation personal message by clicking the note icon. From interface 500, a user may delete a pending invitation. The user may select delete, e.g., by clicking on the ‘X’. The user may be prompted to confirm that the user wants to delete the invitation. If the user confirms the deletion, the invitation may be removed from interface 500. Software module 165 may generate a message to the inviter that the invitation was deleted with the last number of attempts and the last email status, if any. The message may also include the details of the invitation. Interface 500 may also display an email status field, which may contain any email error result at attempted delivery of external email. Interface 500 may also display whether an invitation has been accepted or rejected. If an invitation has been accepted, the user may be presented with options of Goals, Notes, and/or Message. Selecting any of these options, e.g., by clicking on them, may redirect the user to an interface displaying a goal creation wizard page, or the messaging page.

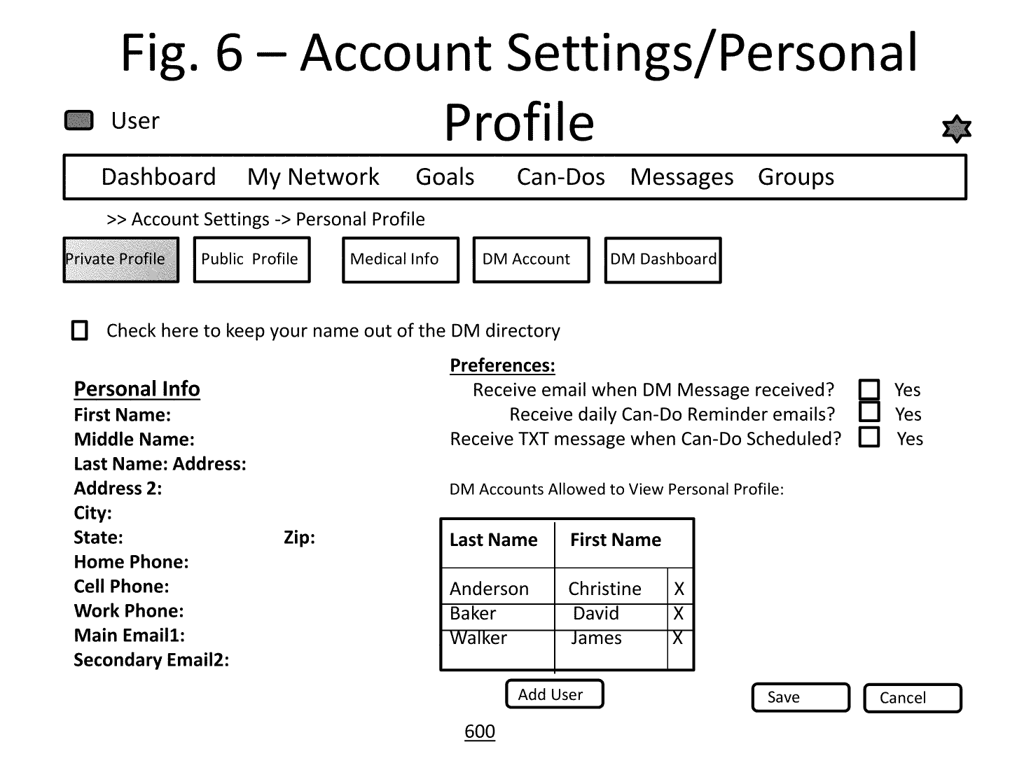

FIG. 6 depicts an exemplary interface 600 for managing account settings in accordance with one or more embodiments. Interface 600 may display personal information for the user, including but not limited to a first name, middle name, last name, address, address 2, city, state, zip, home phone, cell phone, work phone, main email 1, secondary email 2, or any combination thereof. Interface 600 may provide an option for a user to prevent the user from being shown in the list of service users provided by the invitation screen. Selecting the option, e.g., checking the check box, may prevent the user from being listed in the service directory. Interface 600 may provide an option for the user to designate one or more other service users as being in the user's network, and thereby being permitted to view the user's private profile. For example, the user may select Add User, e.g., by clicking on it, which may result in a pop-up window being displayed listing all of the users in the user's network. Interface 600 may provide a list of Preferences the user can select which specifies how the computer system 100 will communicate with the user. Options such as receiving an email or text message when an internal Delight Me® message is received, and receiving a daily email of the current day's Can-Dos with a link to login to the computer system 100.

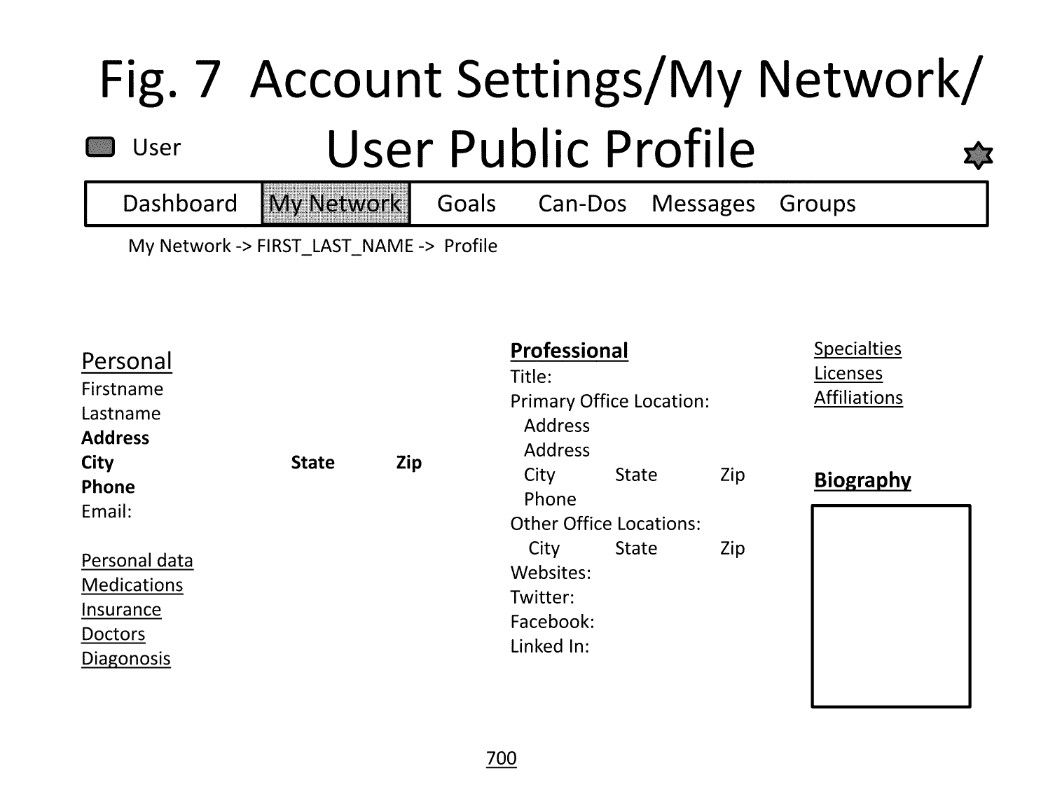

FIG. 7 depicts an exemplary interface 700 for viewing a service user's profile in accordance with one or more embodiments. Interface 700 may present information stored by the service about the user. For example, interface 700 may display the personal and/or professional information depicted on interface 700. In some embodiments, interface 700 may prevent the display of some information unless the user viewing the profile has been given permission by the user whose information is displayed by the profile. For example, the personal address, city, state, zip, phone, personal data, medications, insurance, doctors, and diagnosis may only be visible if the user whose profile it is has given permission to the logged in user to view that information. In some embodiments, interface 700 may present links to Personal Data, Medications, Insurance, Doctors, and Diagnosis. Selecting these links, e.g., by clicking on them, may open a pop-up to show more information about those fields, but as discussed above, access to this information may be granted or denied based on permissions granted by the user.

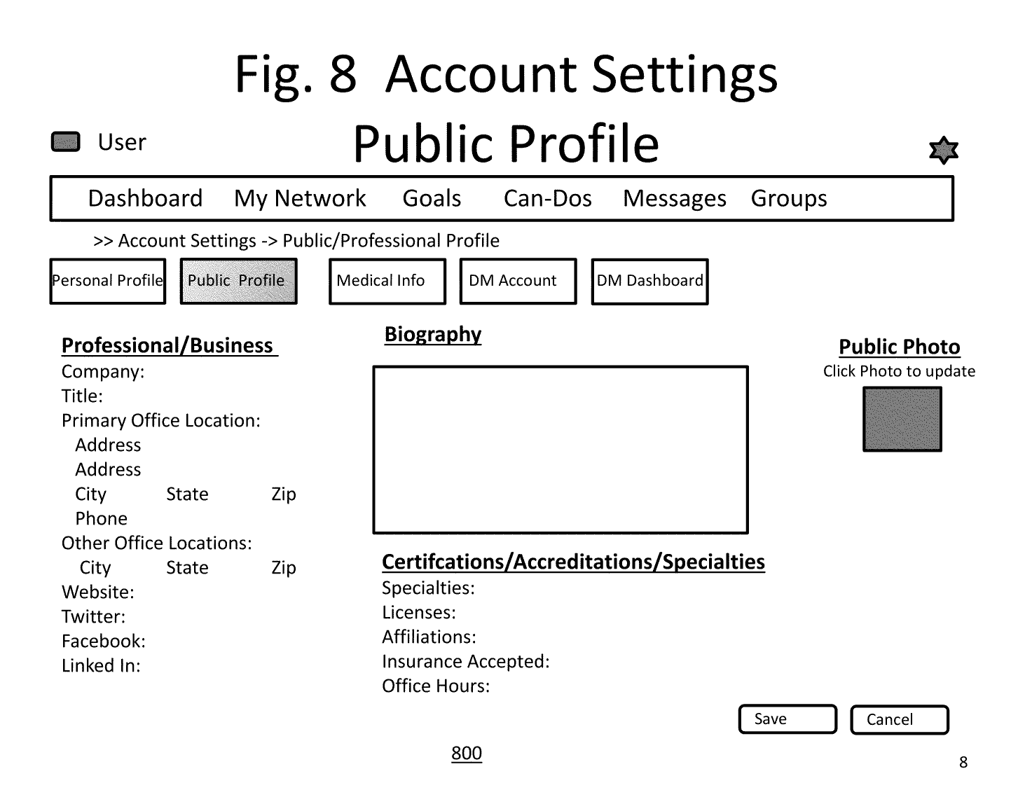

FIG. 8 depicts an exemplary interface 800 for editing a user profile in accordance with one or more embodiments. Interface 800 may provide one or more user-editable fields for adding, modifying, editing, or deleting information. For example, a user may be able to add, edit, modify, or delete information for any of the fields depicted on interface 800. A user may select save, e.g., by clicking on save, to save the information. A user may select cancel, e.g., by clicking on cancel, to exit interface 800 without having any alterations made to the user's profile information.

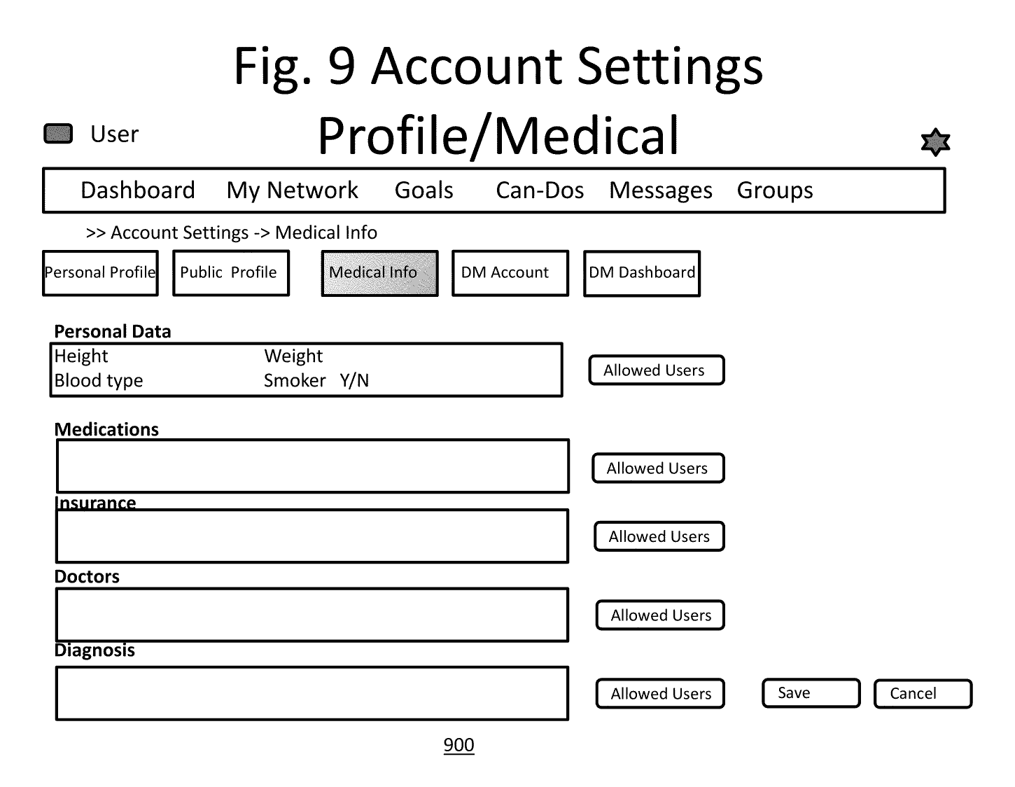

FIG. 9 depicts an exemplary interface 900 for editing medical information in accordance with one or more embodiments. Interface 900 may provide one or more editable fields to a user. For example, interface 900 may provide editable fields for personal data, medications, insurance, doctors, diagnosis, or any combination thereof. Personal data may comprise four field/value pairs of personal data, e.g., height, blood type, weight, whether the user is a smoker, and their respective values. Each section may allow for the setting of specific users that are able to view the data in the field. For example, a user may select the allowed user button corresponding to the personal data field, e.g., by clicking on it. In response to selecting the allowed user button, a pop-up showing a list of the current system users in their network. At the top of the list may be users that can view the personal data, followed by the remaining Network users, e.g., in alphabetical order. The user can select one or multiple users from the list to grant access to the personal data information or to review users from accessing the personal data information. The user may be presented with a save button in the pop-up, from which the user can select save to commit the changes. In response to a user saving changes, a message may be generated by software module 165 and transmitted to those users that have been deleted or added to view specific fields of the user. Interface 900 may also include the ability to for a user to save or cancel changes made to the information in interface 900.

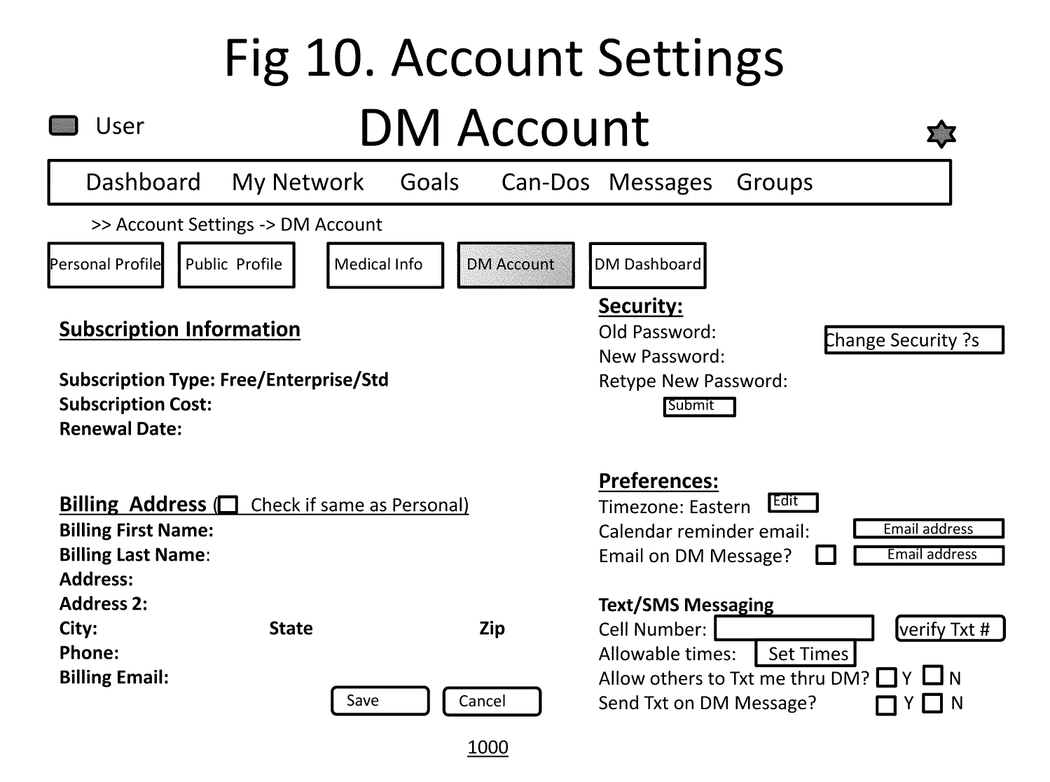

FIG. 10 depicts an exemplary interface 1000 for editing user account settings in accordance with one or more embodiments. Interface 1000 may provide one or more user-editable fields for adding, editing, modifying, or deleting account settings information. Interface 1000 may provide a subscription type of a user. A user may be a complimentary user, e.g., a user given free access during a trial period of the service. A user may be an enterprise user if the user was added under an enterprise. Interface 1000 may allow a user to change the user's password. The computer system 100 may require that the password entered by the user needs to be greater than or equal to seven characters and include at least one letter and one uppercase character. Software module 165 may store the received password in encrypted form, e.g., as a bcrypt or equivalent hash with a CSPRNG salt.

Interface 1000 may allow a user to setup and/or change security questions. For example, three security questions may be used. The security questions may be used when resetting a user's password. Interface 1000 may allow a user to select whether or not the service sends an email to the user when service messages have been sent to the user. The user may toggle this option using the checkbox depicted on interface 1000.

Interface 1000 may allow a user to setup text message and/or SMS message options. The user may verify the number provided by selecting the verify txt # button, e.g., by clicking on it. Software module 165 may cause a test SMS and/or text message with a Ndigit code that the user may enter in the pop-up on interface 1000, which will serve to validate the phone number is the user's. There may be a timeout of two minutes in which case the process may need to be repeated in order to ensure validation. Once the number is verified, the button next to the cell number may become a display-only field of VERIFIED. Using interface 1000, the user may manage other text and/or SMS message settings. For example, the user may specify whether or not the service will send a text message to the user's phone when a service message is received. The user may specify allowable times for the service to send text messages to the user. For example, the user may select Set Times, e.g., by clicking on it, to activate a pop-up, which may present a 24-hour schedule to allow a continuous range of times the computer system 100 may send a text message. The user may specify whether other users may send a text message to the user through the service. The user may specify whether the service automatically sends a text message to the user if a service message is received.

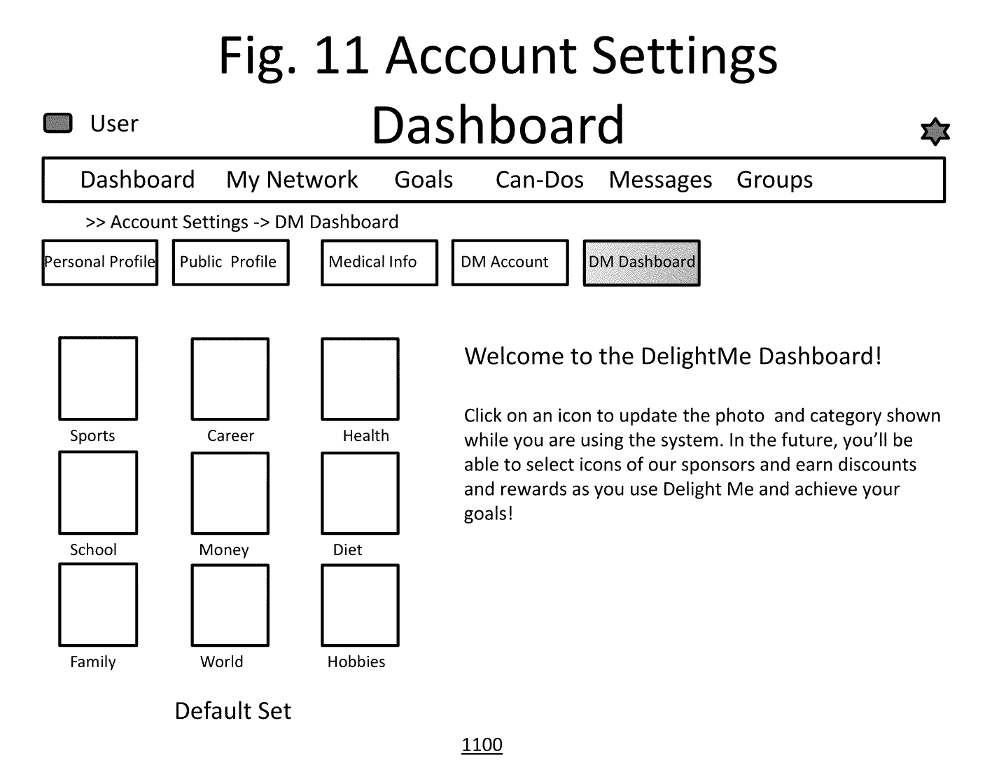

FIG. 11 depicts an exemplary interface 1100 for editing dashboard nine (9) photos which represent goal categories in accordance with one or more embodiments. Interface 1100 may display a set of icons associated with particular categories or allow the user to enter custom categories. These photos are used to enable the user to group goals under specific categories and to enable the easy filtering of the data displayed on the current page. For example, if a user clicks on a photo of a soccer ball which represents Sports goals, the display may be updated to only show Sports related goals. A user may click on an icon to update the photo and label shown while the user is using the computer system 100. In some embodiments, a user may be able to select photos from sponsors and earn discounts and/or rewards as the user uses the service to achieve the user's goals. Clicking on an icon may bring up a file transfer window which may allow the user to select an image file, e.g., a jpg, gif, png file, on the user's system to upload it in place of the currently presented icon.

### Creating Groups

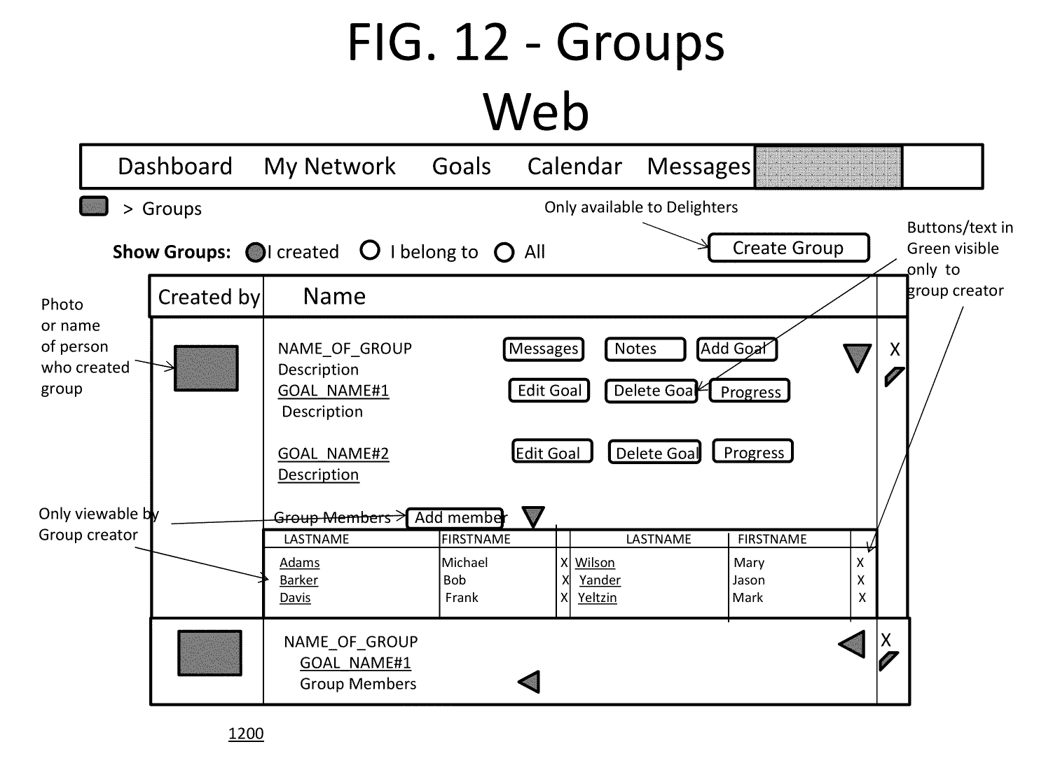

FIG. 12 depicts an exemplary interface 1200 for managing groups in accordance with one or more embodiments. Interface 1200 may display one or more groups to the user. The user may select whether only groups created by the user are displayed, whether only groups the user belongs to are displayed, or whether all groups are displayed, any of which may be a default view when the user arrives at interface 1200.

Interface 1200 may allow a user to create a group. When creating a group, a user may name a group, select group members, and create goals. In some embodiments, only users in the user's network may be selected as group members. After group members are selected, a user may save the group settings entered up until that point. When creating a goal, a user may be directed to a goal creation screen, on which the user can define Can-do items. The can-do items may be those discussed in the goal creation sequence. The user may save the settings as a draft, or may save and send, which may perform the same actions that are performed during individual goal creation.

Certain features depicted on interface 1200 may be enabled or disabled based on the user's role in the group. In some embodiments, certain buttons, text, or display elements may only be visible or otherwise available to group creators. For example, the Edit Goal, Delete Goal, Add Member buttons and list of group members may only be visible to the creator of that group.

Interface 1200 may allow a user to send a message to the members of the group. A user may select the messages button, e.g., by clicking on it, and be directed to a messages screen with fields prepopulated with group information, such as placing the Group Name in the TO: field and a chronological list of messages to/from the Group Name and cursor in the Subject field.

Interface 1200 may allow a user to create a private note related to the group. A user may select the notes button, e.g., by clicking on it, and be directed to a page (e.g., Groups/Group Name/notes) associated with the Group Name, in which the Group Name is selected and a cursor is in the subject field. Past notes may show previous private notes chronologically.

Interface 1200 may allow a user to add a goal for the group. A user may select the Add Goal button, e.g., by clicking on it, and be directed to the Goals Wizard screen. Interface 1200 may allow a user to edit a goal for the group. A user may select the Edit Goal button, e.g., by clicking on it, and be directed to the Goals Wizard screen. Interface 1200 may allow a user to delete a goal for the group. A user may select the Delete Goal button, e.g., by clicking on it, and be prompted to verify that the Goal should be delete. If the user verifies that the goal is to be deleted, software module 165 may generate messages to all members that the goal was deleted and may remove can-do items from calendars.

Interface 1200 may allow a user to view group progress. A user may select the Progress button, e.g., by clicking on it, and be directed to a page showing group progress, e.g., a Groups/Progress/GOALNAME page showing a graph of aggregate data values.

Interface 1200 may allow a user to add a group member. A user may select the Add Member button, e.g., by clicking on it. The user may then be presented with users in the user's My Network, and can click on the member's last name or entry to get a pop-up display of the member's user profile information. If the user adds another user to the group, software module 165 may generate a message to the new member to review and/or accept the goal. Interface 1200 may allow a user to remove a member from the group. A user may select the ‘X’ next to a group member's entry, e.g., by clicking on it, and be prompted to verify removal of the member from the group. If the member is removed from the group, the computer system 100 may send a message to the member that they have been removed from the group and may update the member's calendar to remove Can-do items. The computer system 100 may also archive the goal and data for the user.

Interface 1200 may allow for a user to delete a group. A user may select the ‘X’ next to the group entry, e.g., by clicking on it, and be prompted to verify deletion of the group. If the group is deleted, the computer system 100 may archive the goal and data for the user, and can-do items may be deleted from members' calendars as well as deleting the group.

Interface 1200 may allow a user to edit the group details. A user may edit the name and/or description of the group using interface 1200.

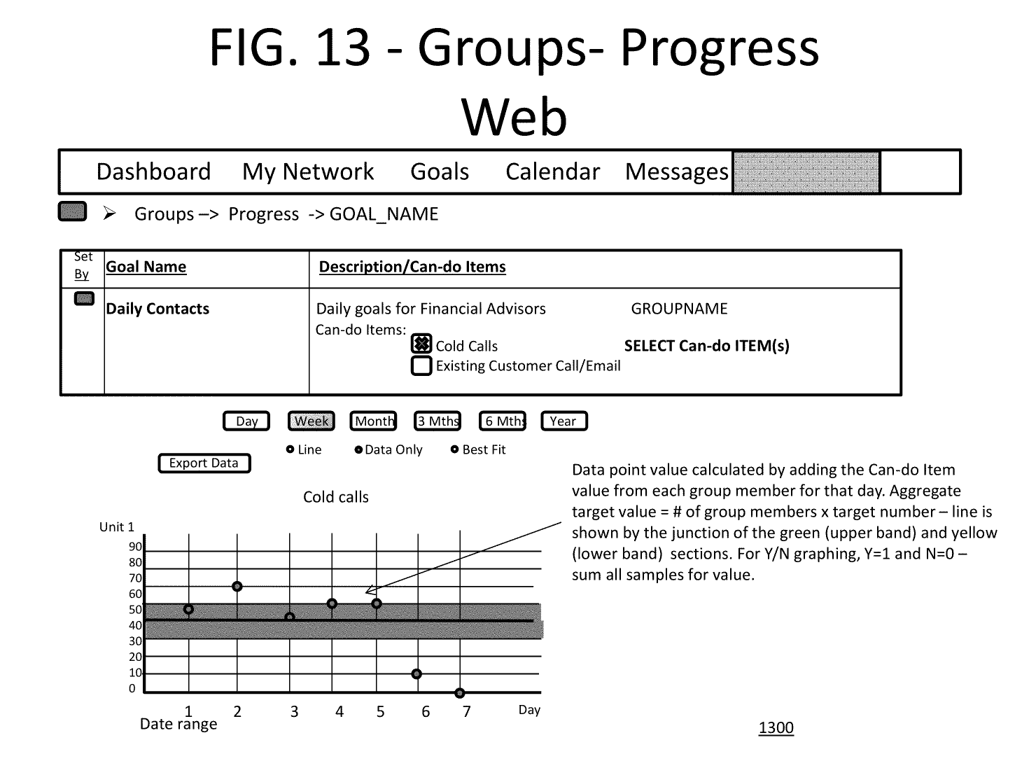

FIG. 13 depicts an exemplary interface 1300 for presenting group progress in accordance with one or more embodiments. Interface 1300 may present graphical representations of data points associated with one or more goals and/or one or more can-do items. Data point values may be calculated by adding the Can-do Item value from each group member for that day. Aggregate target value may refer to the number of group members times a target number. For example, interface 1300 depicts the aggregate target value as the line shown by the range of the green (upper band) and yellow (lower band) sections. For Y/N graphing, Y=1 and N=0, and all the samples may be summed to determine the value. A user select, using interface 1300, which of the daily goals and/or can-do items are displayed in the graph. The user may also select, using interface 1300, a time frame over values to display. For example, a user may select to display data for a day, a week, a month, 3 months, 6 months, a year, or any other time frame during which values are available. Interface 1300 may allow a user to export data. Data may be exported via a button on the screen where the user will get an option to select the format of the data, such as XLS, CSV, TXT, XML, etc. Thus, the computer system 100 can include an export unit that allows for a user to export the graph data.

### Goal Management and Tracking

The computer system may allow a user to view the user's goals, view other users' goals they are coaching, view the can-dos associated with any goal as well as progress graphs.

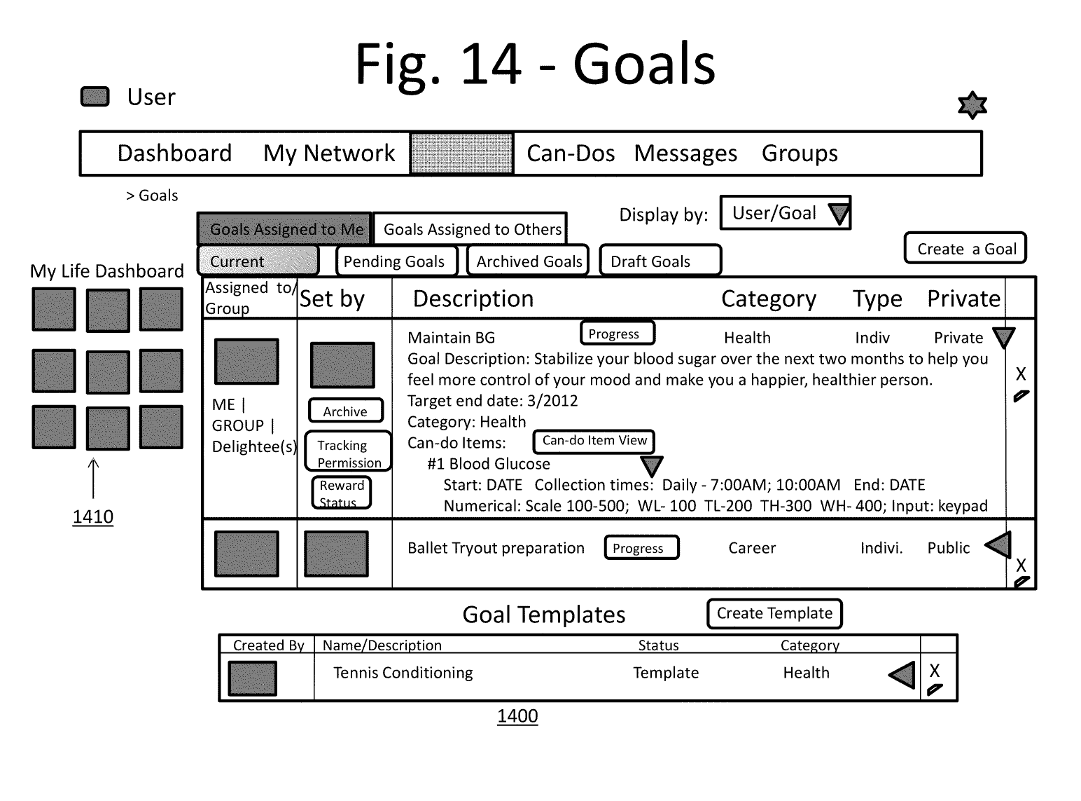

FIG. 14 depicts an exemplary interface 1400 for managing goals in accordance with one or more embodiments. Interface 1400 may show a view of Goals that are assigned to the user, or a view of goals they have assigned to others as their coach. Interface 1400 may show have tabs the user can select to show goals in specifics states such as Current/Pending/Archived/Draft. In some embodiments, interface 1400 may display each tab only if there is data to be displayed for the tab. The current tab may show all currently active goals that either have been assigned to logged in user or that they have set. The pending tab may show goals that have been assigned to logged in user but not yet approved or accepted.

Interface 1400 may enable the user to edit the Archive, Tracking, Sponsor Status, Progress, Active state, and whether Can-dos are displayed. Archived goals may be those goals that have been completed or disabled and the user would like to keep the data. Tracking/Sponsor Status/Progress/Edit action may not be available. Archive goals may become Unarchived. Draft goals may be those goals the user is creating but has not completed. For draft goals, only Edit/Delete may be available as options, and may be edited, e.g., according to the techniques described herein.

Interface 1400 may enable a user to filter the display results based on who the goal is Assigned to (e.g., the user, all users, delightees), by category, a per goal basis or any combination thereof. Interface 1410 may show photos of selected nine categories goals defined and created in FIG. 11 to enable easy display filtering of the goals shown on the page by clicking on one or more of the photos.

Interface 1400 may enable a user to create a goal by providing a create a goal button, which may take a user to a Goal Wizard screen which enables creation of all the parameters of a goal. Interface 1400 may allow a user to view the progress of a goal by clicking on a progress button or graph icon, which may take the user to a goals progress page a tabular view of raw data or display a graph of the data collected for the goal, so the user can view progress. Interface 1400 may enable a user to view a Can-dos for a goal, e.g., by clicking on a can-do item view button, which may show the user a list of can-do items view, and allow the user to click on the Can-Do name or icon to expand/collapse a more detailed view. Interface 1400 may allow a user to Archive goal if they are owner/creator, which may ask a user to confirm archival. If accepted, software module 165 may change the status of the goal to archived; generate a message to Goal participant(s), e.g., (From: the computer system 100) that the goal, e.g., GOALNAME, was archived; remove all Can-do items from current calendar of user(s)/delightee(s). Interface 1400 may allow a user to set tracking permission, which, in some embodiments, may only be viewable to user if they are delightee of goal. If selecting tracking permission, a pop-up may list the users My Network and gives the user the ability to deselect users as well as add additional user w/tracking permission; if users de-selected/selected, generate a message to affected users (From: User) that they are now able to track this goal. Interface 1400 may provide a reward status button, which, in some embodiments, may only be shown if this goal has been created with a defined reward. If selected, the reward status button may present a popup that shows current status, e.g., as a percentage of reaching the required goal; show details of reward and requirements if a Details link is clicked on, which may show date/time/reward table along with description of the requirements and the reward. Interface 1400 may provide a create template button, which, when selected, may bring up Goal Wizard screen. These goal templates may available for selection in Create a Goal sequence.

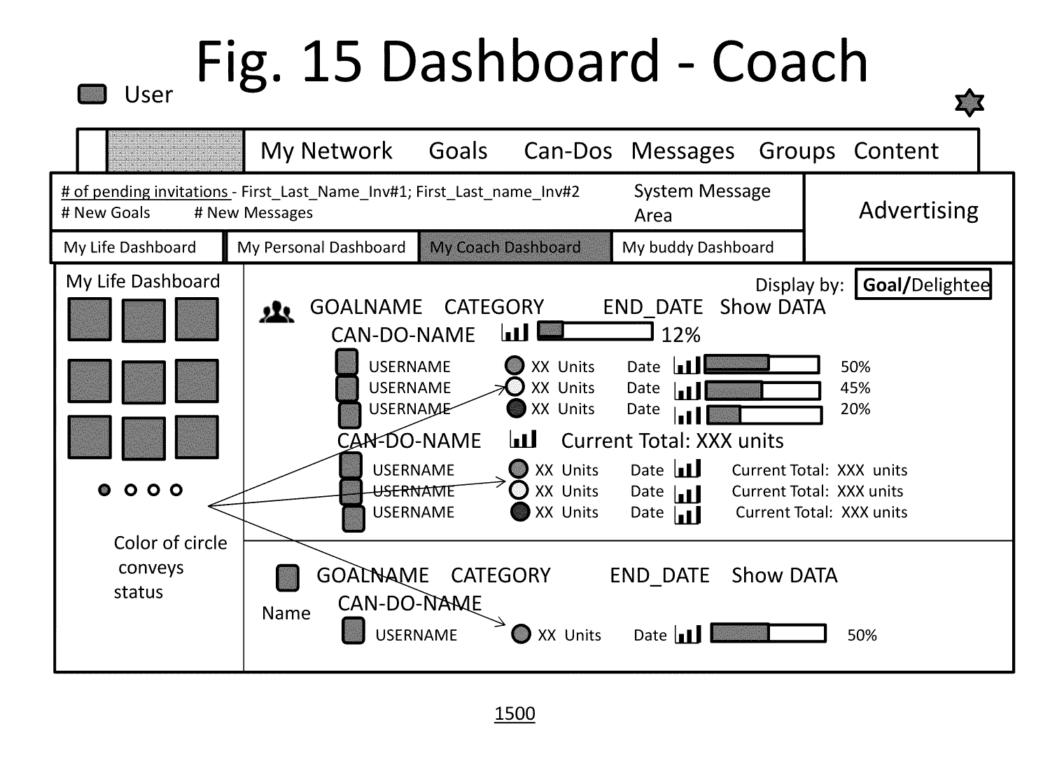

FIG. 15 depicts an exemplary coach or delighter interface 1500 in accordance with one or more embodiments. Interface 1500 may provide a system message area, which may present maintenance information, system notices, and/or goal related messages. Interface 1500 may provide a System Message subsection, which may include pending invitations, accepted invitations, number of new messages, number of pending goals, number of draft goals, or any combination thereof. Pending invitations may include a link so that when a user clicks on any displayed name, the user is redirected to the tab of Outgoing list of invitations. If there are too many items to display, an indicator, e.g., “ . . . ”, may be shown, which will be clickable and will take the user to the Outgoing list. Accepted invitations may include a link so that when a user clicks on a name it takes the user to the My Network/Basic tab for that user. Number of new messages may include a link so that when the user clicks on the #New Messages link, the user goes to the Messages tab. Interface 1500 may present one or a set of 9 icons which can be customized in Interface 1100. These icons can be used to filter the current display to show data related to the selected category(s). Multiple icons can be clicked to provide the equivalent of a logical OR in the displayed data. Multiple sets of 9 icons can be chosen by selecting on of the circles below the set of 9 icons. Circles only appear if more than one set of 9 icons have been defined.

Interface 1500 may present data by any number of sorting methods. Data can be displayed on a per goal basis in which may be sorted alphabetically and will list all users under each goal. Alternatively, the data can be displayed on a per user basis and all the goals that each user has been assigned can be listed.

Interface 1500 may present a goal view showing group goals labeled by a special group icon or individual's goals labeled with the users profile photo. Goals may have summary parameters shown such as category, one or more Can-Do sections, projected goal end date and a link to show the data gathered to date for the goal. Each of these text items may be a clickable link to obtain further details about the data object or perform an additional action. Each Can-Do heading may have a graph icon that can be clicked to provide a visual view of the current progress of the Can-Do as shown in interface 3000. This graph may show cumulative data on a daily basis for any interval, or may show a cumulative view to date on a per user basis. The graphical display may also enable the coach to export the data in raw format for incorporation into external programs for processing. Each Can-do heading may have a bar graph and a percentage value or a cumulative total on progress to date for that Can-Do.

Under each Can-Do heading there may be one or more users that have been assigned to the goal. Each user may have data such as a colored visual indication of their status of performing the Can-Do. The color may indicate activity in performing the Can-do. For example, red could indicate a fault state; yellow could indicate a warning state; green could indicate a valid state and blue could indicate a not yet started state. Additional data for that user may also display the last Can-Do data collection date and value. Interface 1500 could also have icons next to each user which enable the coach to view a graph of the individuals progress. Graphs may also have the ability to export the underlying data so that external programs can be used to process the data. Each user may have a bar graph and a percentage value or a cumulative total on progress to date for that Can-Do.

Interface 1500 may also contain an area of the screen set aside to display advertising data to the coach by the advertising management unit. Advertising content may be provided by 3rd parties, other Delight Me® account holders or Delight Me.

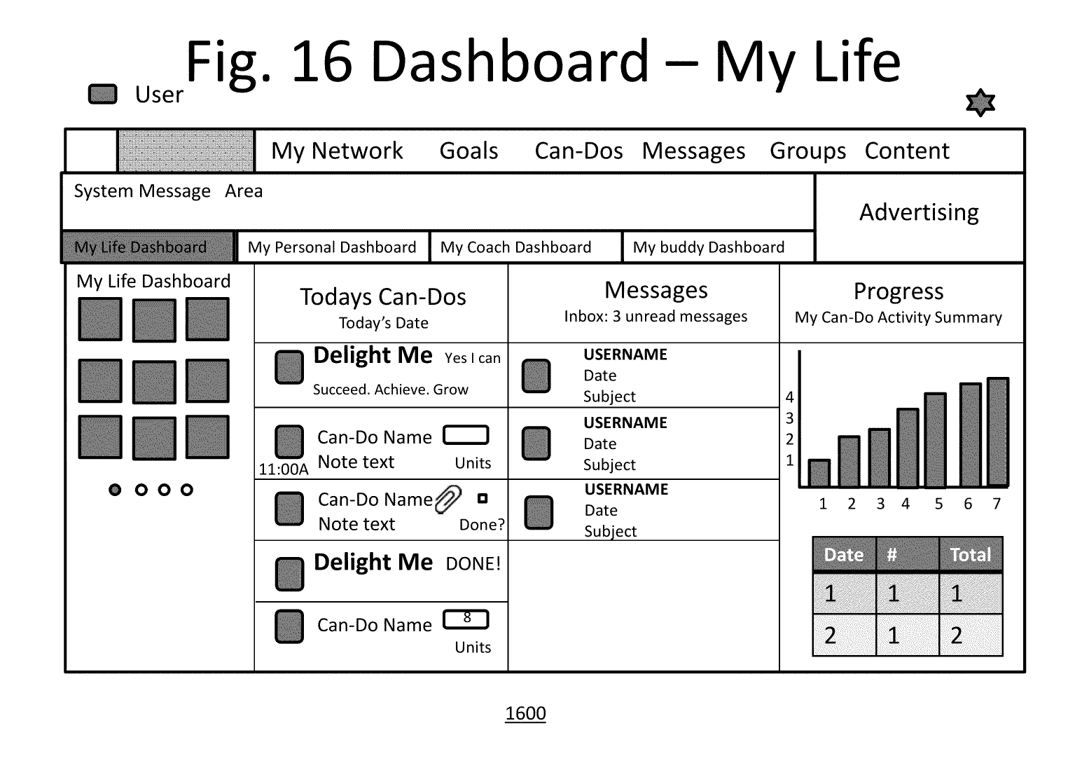

FIG. 16 depicts an exemplary dashboard interface 1600 in accordance with one or more embodiments. This Dashboard page appears when a user initially logs in. When a user clicks on one of the 9 category icons being displayed, it may modify the data displayed anywhere on the screen to match the category(s) of the icon(s) selected.

Interface 1600 may contain a section which displays Today's Can-Dos. Can-Do's may be displayed in chronological and/or alphabetical order. The section may be divided into Can-Dos which are still to be done and Can-Dos that are Done delineated by section headings. Each Can-Do name may have an attachment file indicated by the presence of a paperclip icon. A Can-Do may also have text of a note related to that specific Can-do below the Can-do name. If that text is longer than the display area, an ellipsis may be shown to indicate existence of more text to view. The text associated with the note can describe information related to the input of the Can-do field. For example, if a can-do related to a student obtaining good grades in one category, and a can-do in another category such as obtaining sufficient sleep, having an ability to enter information regarding an explanation of the achievement of the can-dos (such as nausea) can help to better explain the data. At the aggregate level for an individual or for groups of individuals, the actual value data surrounding achievement of can-dos and goals allows for modeling, predicting and hypothesizing in various categories of human behavior or human-related or non-human data for non-human modeling, predicting, and hypothesizing. For example, data can be tracked that is associated with caring for a garden or many gardens, caring for one tree or many trees, managing one landscaping client or many landscaping clients. Further, the system can be used to track the impact of water, rain, sun, fertilizer, bugs, etc. Further, the system can be used to track the caring for or maintenance of a house or building or group of buildings. In one embodiment, the system can be used for modeling, tracking anything. In some embodiments, this can include animate, inanimate, financials, machines, parties, sales, etc.

The Can-do may also have a data entry field like a check box or a data input field. The data entry field may also have text below it to indicate what checking the box means (Done) or units related to the data entry. Can-Dos that have data entered may have numbers, letters or checkmarks to indicate some action has been taken against them. Any of the text shown may be clickable to show more information about the object or to enter or change the state of the data.

Interface 1600 may have a Messages section that displays in chronological order of all messages received. Each message may contain a profile photo of the user; a date, a subject and may be bold or normal text to indicate the status of the message (read or unread). Any of the objects of the message (photo, name, date, subject) may be clicked to provide more information such as the users profile, or provide navigation to another section of the computer system 100.

Interface 1600 may have a Progress section that shows a simple progress graph for a GOALNAME or a summary view of all data entry events over a configurable time period. The initial default is a summary view of the number of data entry events over a 7 day timeframe starting with the previous 7 days. Clicking on the Progress heading may take the user to Progress menu item and shows a summary of all goals selected for 1 or more weeks. The Progress section may have a drop down menu allowing the user to click on a GOALNAME that allows user to select a goal and a Can-Do for default display in the interface. The selection may be persistent after being selected between logins.

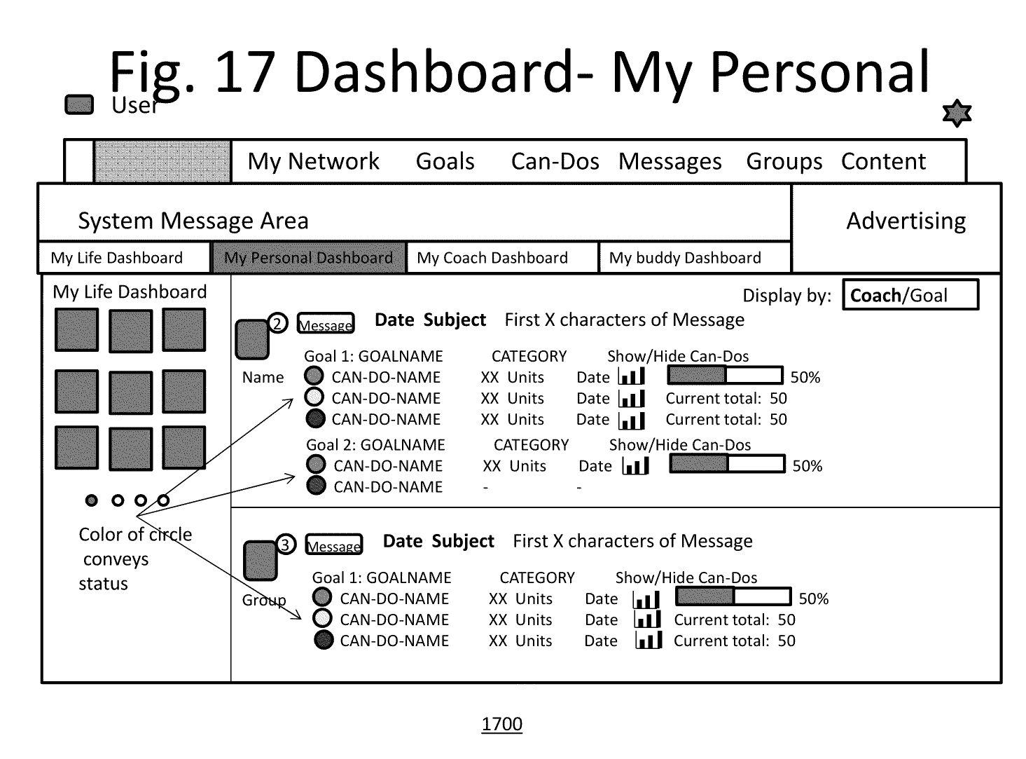

FIG. 17 depicts an exemplary My Personal Dashboard interface 1700 which shows the logged in users personal view of their goals. Interface 1700 can display a view of personal goals on a per coach basis or on a per goal basis via a selection method such as a drop down list. Additionally, the set of 9 displayed icons enable the user to filter the display by one or more categories associated with the 9 icon(s) clicked. The default view in interface 1700 is by coach and may show all goals defined for the current user by specific coaches. The display may contain a circle with a number in it next to the profile picture of the coach to indicate a number of unread messages pending from that coach. Next to the profile picture and new message indication may be a Message button allowing the user to compose a message pre-addressed to the coach. Next to the button may be a portion of the latest message received from the coach with a Date, Subject, and sampling of the first characters of the message. This message may contain state information by being bold to indicate it has not yet been read.

Interface 1700 may contain a list of the goals that have been assigned to the user by their coaches and data conveying the status of the goal. Each goal may have one or more Can-Dos shown along with data elements conveying the status of the Can-Do. A text link Show/Hide Can-Dos may be available to let the user hide the Can-Do data for each goal to simplify the screen for viewing. Some Can-Do data elements may be present such as a visual color status of a Can-Do (red, yellow, green, blue), a Can-Do name, the last data entry value and date. In addition, a graph icon may be present to enable the user to see the data for the Can-Do in a graphical format as is shown in interface 3100. Another data element may be a progress bar depicting the percentage completed to date for this user, or just a cumulative total of the values of a Can-Do. Interface 1700 may have a System Message Area to display messages to get the attention of the user, and may also have an Advertising area to display third party or DM generated messages ads.

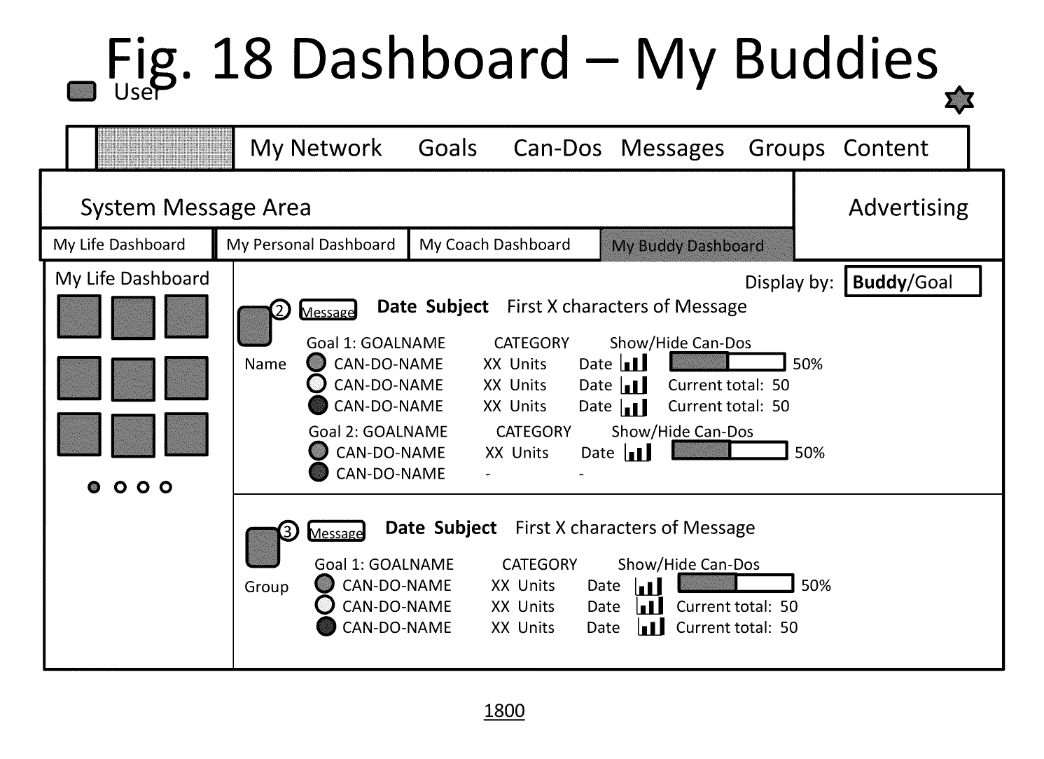

FIG. 18 depicts an exemplary My Buddies Dashboard interface 1800 which may show the status of friends of the user and the status of their goals. Users of the Delight Me® system can give permission to another user(s) in their network who is not their coach but a Buddy, to provide moral support an encouragement in achieving their goals. The data shown may be similar to that in interface 1700 with the same functionality on category filtering and a view by Buddy or by Goal.

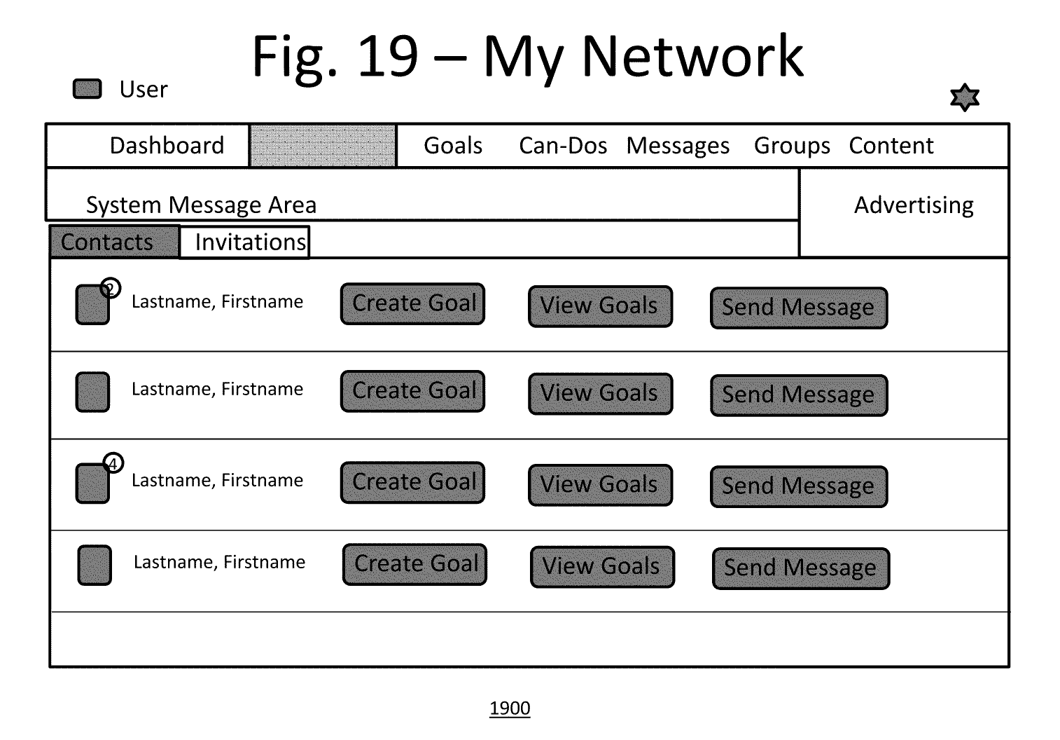

FIG. 19 depicts an exemplary interface 1900 displaying the members of the user's private network. Each member of the network may be displayed with their profile photo and their name. The profile photo may also have an indication via a circle with a number in it to indicate a number of unread Messages may be waiting for the user. The user will then have the option to click on that circle which will navigate the user to a list of messages that have been exchanged with that user. A number of action buttons may be shown next to the contact name which enables the user to perform functions with that contact. Example functions may be to Create Goal, View Goal or Send Message to the contact. The user can then be taken to the page, or view a pop-up model of the button function selected.

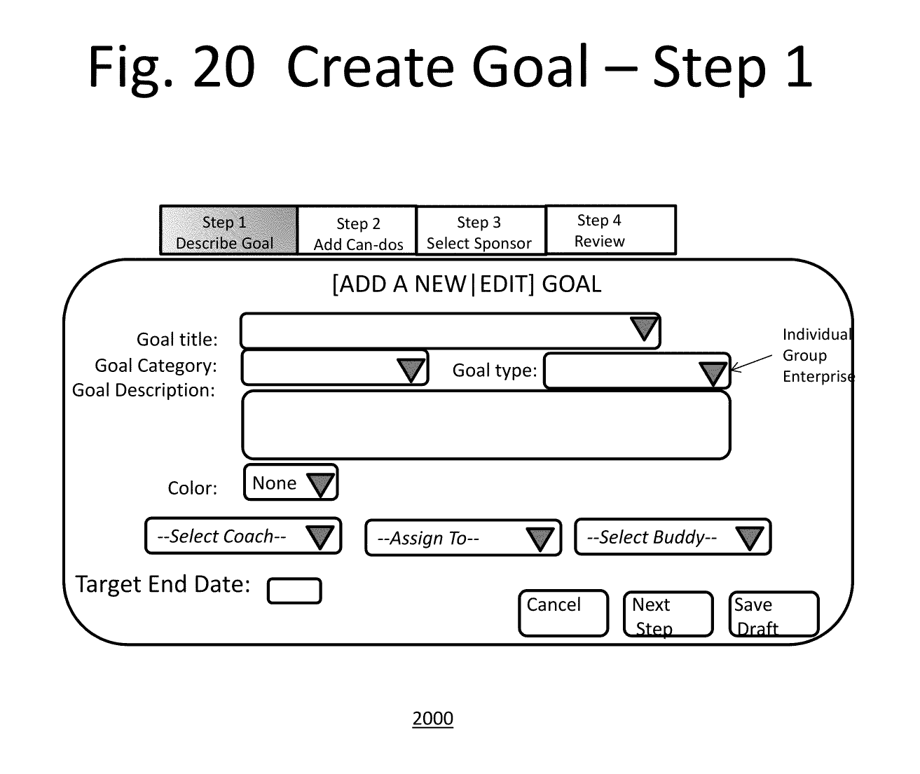

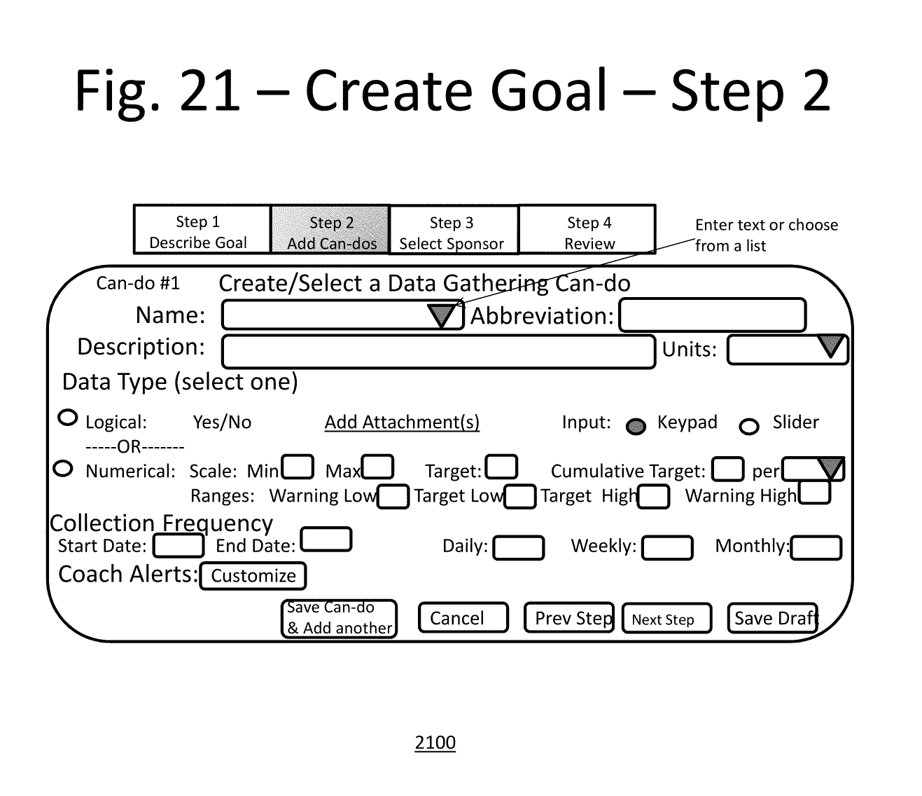

FIG. 20 depicts an exemplary interface 2000 for adding a new goal or editing a goal in accordance with one or more embodiments. This screen may be seen for each type of context. If the goal is a New goal, the user cannot skip steps 1, 2, 3; however, if editing a goal with content in Step 1/2, the user can go to each tab individually. The Goal Title may allow input or selection of the title of a Goal (GOALNAME). List of Goals in sections: the first section are previous goals created by logged in user, next are Goal templates created by logged in user, next section are standard DM system goals. Goals may be presented in alphabetical order for each section. Goal Category may list one of the default 9 Delight Me® categories (sports, career, health, school, money, diet, career, world, family, and hobbies) or additional custom categories defined by the user or the organization. A parameter Goal type may be selected to limit the visibility and applicability of the new goal. A parameter Color may be selected for visual enhance of the display of data. On self-assigned goals, the user can select a coach or delighter to oversee the accomplishment of the goal. If a coach is not explicitly selected, the user may select other existing members of My Network to assign the new goal to. Additionally, the user may select one or more member(s) of their My Network to act a Buddy to provide moral support. A Target End Date can be entered or selected from a pop-up interactive calendar to provide a finite date to accomplish the goal. FIG. 21 depicts an exemplary interface 2100 for adding a new goal or editing a goal in accordance with one or more embodiments. A user may interact with the elements depicted on this screen. Name may allow a user to enter a custom Can-do or pick one from a list. The list may contain three groups: Previously defined Can-do Items by this user, previously defined Can-Do items by the users organization, and DM standard Can-do items. The user may select one from the list. If selected from the list, abbreviation and Units and other Can-Do parameters may be automatically populated. Units may allow a user to enter a custom unit or select from a list. A unique alphabetical listing of all units used today by all users or set by DM may be presented for selection. One of two Data Types can be selected via a radio button: Logical Yes/No or a Numeric value. Data Type Numerical may allow a user to select input method of a slider widget between min/max or keypad for numerical input. One or more attachments may be added to the Can-Do which may provide reference information or forms to be completed by the user. Scale may allow a user to enter a Min/Max value expected by a user for data entry, check for numerical input, check for valid numbers. Users may be required to enter precision up to two decimal points (i.e., If they enter 10.0 to 20.0 or 10.00 to 20.00). Target may be a set target value. If min/max set, the target value must be between. Cumulative target may allow a user to set a cumulative target for the Can-do item—e.g., 100 hours of running for the next month. Per-interval for Cumulative target may allow a user to specify an interval, e.g., a day/week/month/year may be selectable options. Ranges may allow a user to set thresholds which can be viewed on progress graphs. Warning Low value is=>Scale:Min, and the Warning high value is <=Scale:Max. The Target:Low<=Target<=Target:High.

Data Collection parameters may be specified. Start Date may specify when to start collection. The value may be null. End Date may specify when to stop collection. The value may be null. Clicking on Daily may display pop-up menu to allow user to select the time(s) of day for data collection. Clicking on Weekly may allow the user to select the days (M-Su) and hour to they are to perform the Can-Do activity. Clicking on Monthly may allow the user to select the days (1-31 or month beginning/end) in a month along with time to notify for collection.

Clicking on Coach Alerts Customize may pop up a screen to allow a user to configure alerts based on data entry values or lack of data entry. The coach may configure the maximum number of intervals they will allow the user to miss before changing the status color shown next to their name or Can-Do in interface 1500 the Dashboard for a Coach. The coach may also select to receive a Delight Me® message, email or text message when the maximum number of missed entries are experience. Alert triggers may be set to multiple of the following: No input for X consecutive samples (default); No input for X consecutive days/weeks/months depending on frequency; Input>X value [for Y consecutive samples]; Input<X value [for Y consecutive samples]; Input outside of Range (below Warn Low or Above Warn High); or any combination thereof.

Save Can-do & Add Another may allow data entered for this Can-do to be saved and directs the user to a screen which summarizes Can-do and allows another Can-do input. Cancel may ask for Ok and remove all data if Ok and return to previous page. Prey Step may temporarily save data entered to this point and goes to Step 1. Next Step may save data entered and go to Step 3. Save Draft may allow a user to stop data entry but save work for later completion. The computer system 100, e.g., by software module 165, may save goal information and mark as a draft; generate system message to logged in user that they have a Draft Goal with Goal Title which has been saved. In message, the Goal Title may be made clickable which brings them to the previous step they were on in the original goal creation process. Interface 2100 may be repeated more than one time for a Goal that contains multiple Can-Do items.

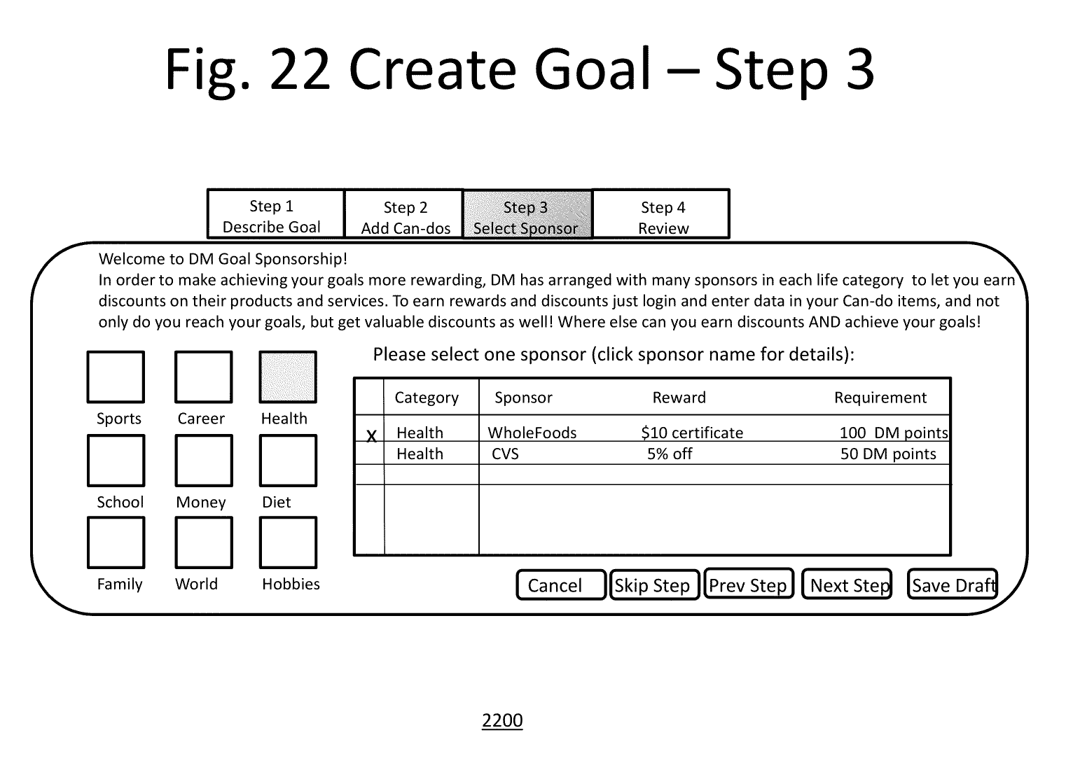

FIG. 22 depicts an exemplary interface 2200 for adding a new goal or editing a goal in accordance with one or more embodiments. A user may interact with the elements depicted on this screen. Icons may be standard DM icons or if user has customized use them for Individual/Group goal. Current Goals category may be highlighted. If the goal is an Enterprise goal, the icons and sponsor information may be changed to reflect that. Sponsor Table may contain a list of sponsors on a per category basis along with short description of the rewards and requirements to get the reward. Table initially only shows sponsors related to the category of the goal being created. If no category was selected, show all rewards sorted by Category/Sponsor name. Goal category is highlighted and sponsors for that category appear in the table. Sponsor/Reward/Requirement may all be clickable in the table and pop-up with the same information about the sponsor, reward and requirement. Clicking on one of these may allow a user can select one sponsor for the Goal. Sponsor table content may include some sponsors and may allow them to be selected for any category or specific categories of Goals. DM Points may be set initially as 2 points for a data entry action and 1 point/day for a DM login. Skip Step may allow a user to move to Step 4 without saving any changes to this step as it may be optional. If user clicks Skip Step, a pop-up asking if they really want to skip this step may be displayed.

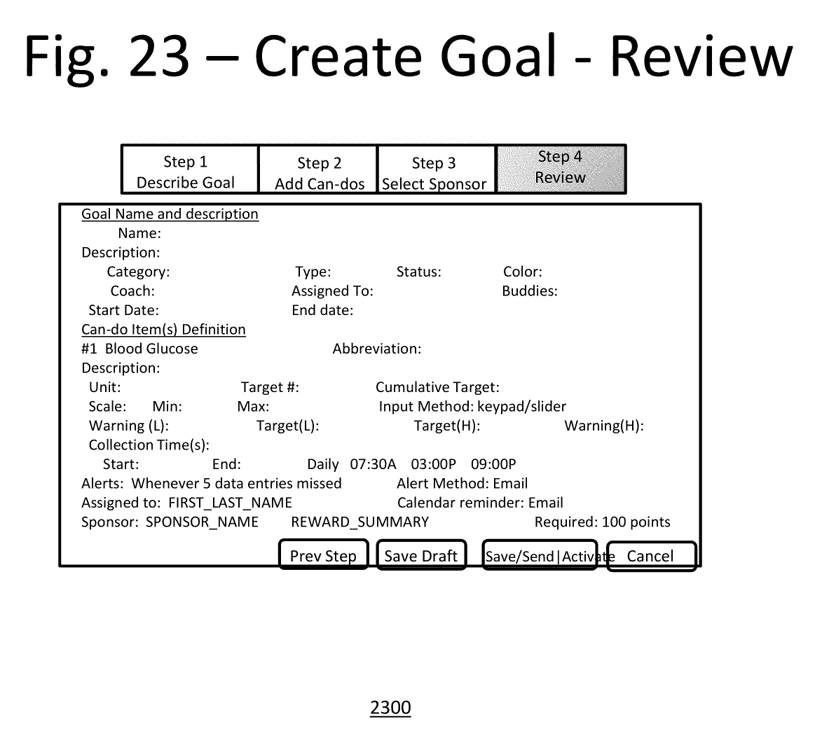

FIG. 23 depicts an exemplary interface 2300 for adding a new goal or editing a goal in accordance with one or more embodiments. A user may interact with the elements depicted on this screen. This screen may contain a summary of all information on the Goal. If the user wants to edit anything, they should hit Prey Step or click on the Field heading which will take them to the appropriate step wherever that field was set. Save/Send|Activate may be an action required to save and Send if this goal being created for someone else or activate if this is a self-created goal. The computer system 100, e.g., by using software module 165, may generate a message to FIRST_LAST_NAME stating there is a new goal for them to view and accept (link in message directly to Goals/Pending for user). The computer system 100 may automatically Add to Pending Goal for assigned user; or if the goal is a self-assigned goal, make goal current and update calendar with Can-do item(s).

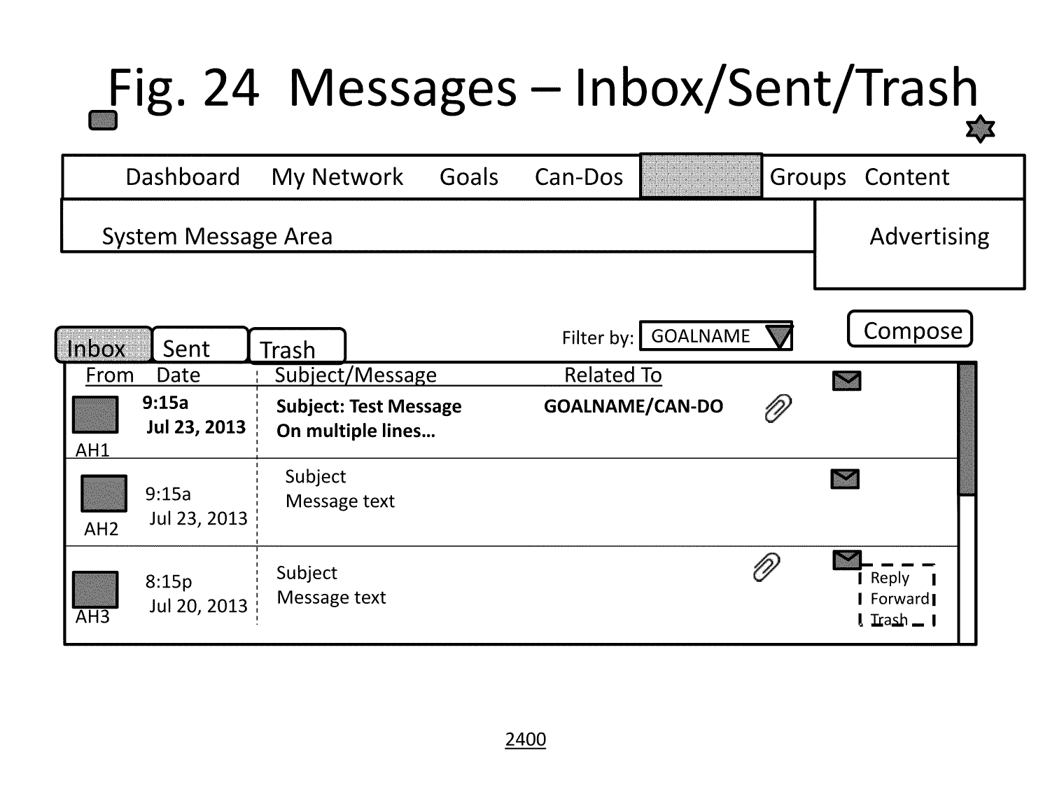

FIG. 24 depicts an exemplary interface 2400 for viewing messages in accordance with one or more embodiments. Messages may show all messages the user has received (Inbox); Sent or trashed in chronological order. Clicking a message may clear the background to non-highlighted white or change the message text to unbold from bold to indicate the status of a message as read or unread in the Inbox. Clicking a message may also take the user to Interface 2500 which shows a conversational view of all the messages to and from a specific user. Messages may be sorted by clicking on the column headings. The message display may also be filtered by Category by clicking on one of the nine icons shown in the display. One or more of the nine icons can be clicked to filter the display. A Message may be Related to a specific Goal or Can-Do during the message creation process and the filtering of the display to only show messages to a related Goal can be done by selecting the goal from the drop down list. The color or style of the text of the selected Related To goal may be modified to indicate a status change from normal (deleted, deactivated). A paperclip icon may be present to indicate a file has been attached to a message that can be viewed and downloaded by clicking on the icon. Additional actions may be performed on a Message by clicking an envelope icon which may allow the user to Reply, Forward or Trash a message. Interface 2400 may also display a Compose button to access a screen to create a new message to one or more My Network users.

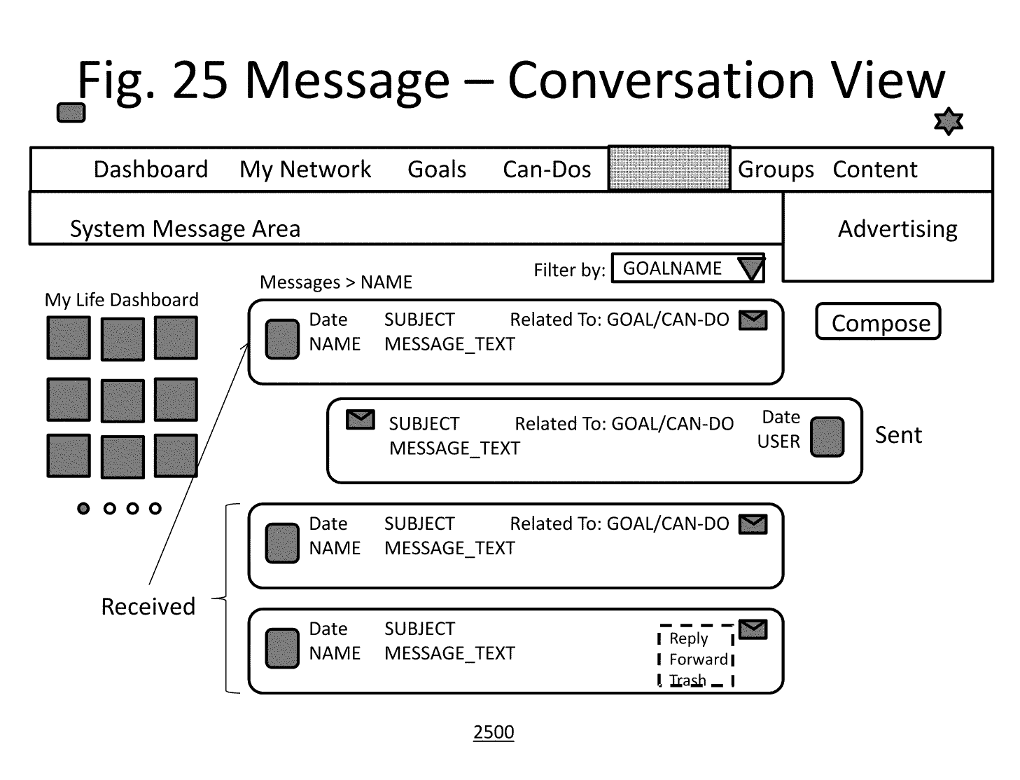

FIG. 25 depicts an exemplary interface 2500 for viewing message in a conversational view with one specific user. Messages may be displayed in a staggering fashion to visually indicate which messages have been received and which have been sent along with the accompanying photo and name that is present in each message. Message background color may also indicate the status of a message as being read or unread. The contents of the Message and the functions available on a per message basis may be similar to those defined in interface 2400.

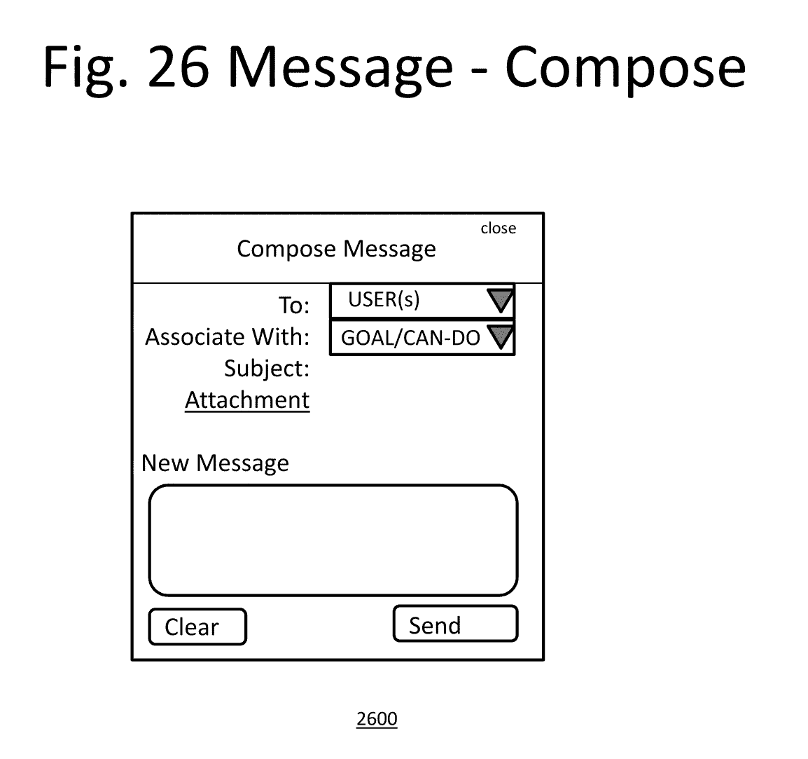

FIG. 26 depicts an exemplary interface 2600 for composing a message. The user may enter a new message. In “To”, the user can type in Last name to match user (AJAX type functionality) or pull down list which shows My Network users, Groups they have defined or Groups they have been placed into, or DM administrator. One or more users or Groups can be selected to receive the message. The user may select to associate this message with a specific Goal or Can-Do for ease of filtering the display of messages. Thus, a messaging unit can be provided that is configured to accept input and send the input in a message from a sender user account node to at least one of a plurality of recipient user account nodes, the recipient user account nodes being in a relationship with the sender user account node. Further, the messaging unit can be configured to associate the message with one of the goals of the user account node.

Clicking Attachment will present the user with an interface to select one or more local file(s) to include with the message. The user may enter one or more lines of text in the New Message area. Clicking Clear may clear all fields in the message. Selecting Send may send the message to the To member(s).

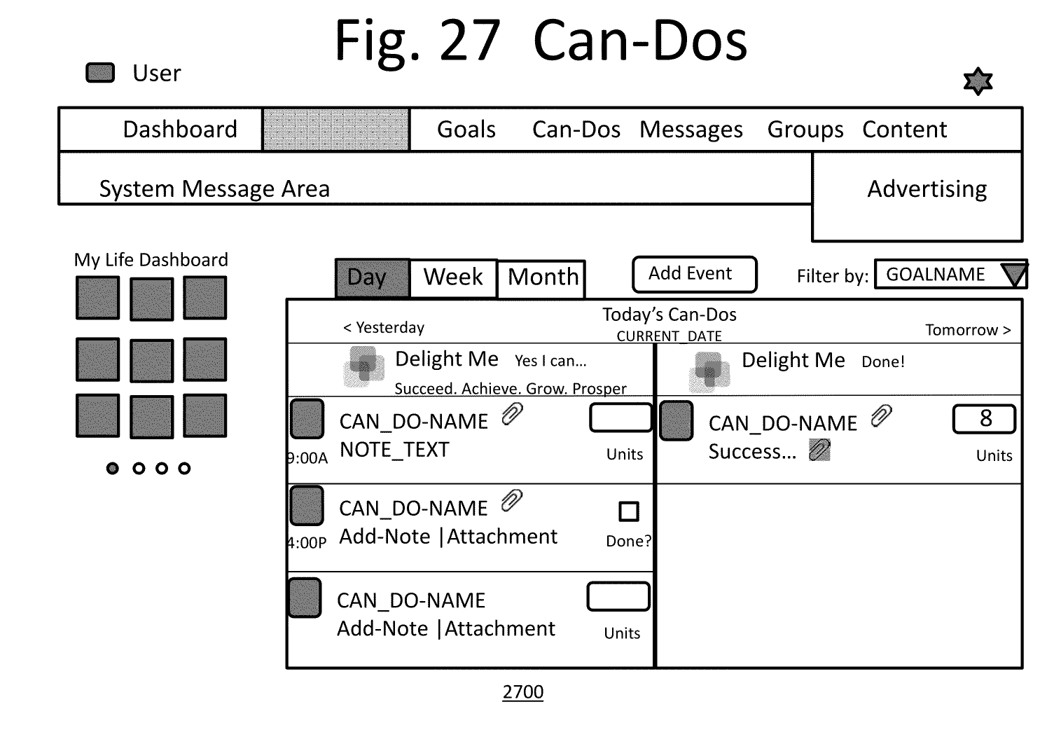

FIG. 27 depicts an exemplary interface 2700 for viewing a current day of personal Can-Dos for the user in accordance with one or more embodiments. The user may be able to select other days by clicking on dates or general terms such as yesterday or tomorrow. The interface may also allow a view of a different time interval such as a weekly or monthly view The list of Can-Do events display may be filtered by category by clicking on one or more of the nine icons. Additionally, the user may filter the display of Can-Dos by selected from a drop-down list of Goals/Can-Dos associated with the current day's events.

The Data Field may allow a user to enter data such as numeric, text, or a checkbox. Clicking on the data field may allow the user to enter alphanumeric or other types of data into the field. Clicking on the Can-Do name field may also provide the user with additional information on the Can-Do such as the overall goal parameters, the Can-Do parameters such as expected range of values. Entering data or clicking a checkbox may move the Can-Do section from the left side of the display (i.e., To-Do) to the right side of the display (Done) to indicate a Can-Do event was completed.

The user may be able to click an icon next to the Can-Do name to view any attachments that have been included with the definition of the Can-Do Clicking Add-Note may enable the user to annotate the Can-Do with explanatory text. Clicking Attachment may allow the user to attach one or more files to the data entry event such as completed forms, audio or video files in support of the Can-Do. Thus, the goal-setting unit can be configured to associate attachment files to each proposed accomplishment or Can-Do, for reference, in a format of a form document, an audio file or a video file

Clicking Add Event may display a popup that allows a user to select the date and time of the event; event name; event description (e.g., limited to 128 bytes); whether the event is private (only they can see it DEFAULT); whether an email alert or text message alert should be sent to themselves. This event appears like a Can-do item in the list for a specific day and may generate an alert pop-up message when logged in but takes no input, just an acknowledgement to the message.

Can-Do alerts: while the user is logged in any event that requires input from them at a specific time may result in a pop-up window which alerts the use that data entry is needed from them. Depending on the settings of the Can-do item, they will either click a checkbox or enter some numerical value. If the input method is a Slider, then the user can use the mouse to drag to the appropriate value and click Ok/Done. If numeric entry required, then a keypad pop-up allowing them data entry. Alternatively, they can click Skip (to skip entry) or Delay (and let them choose 15 min intervals up to 2 hours) which will re-alert them for data entry. The computer system 100 may allow up to 2 delays otherwise just present them with a Skip/Done option.

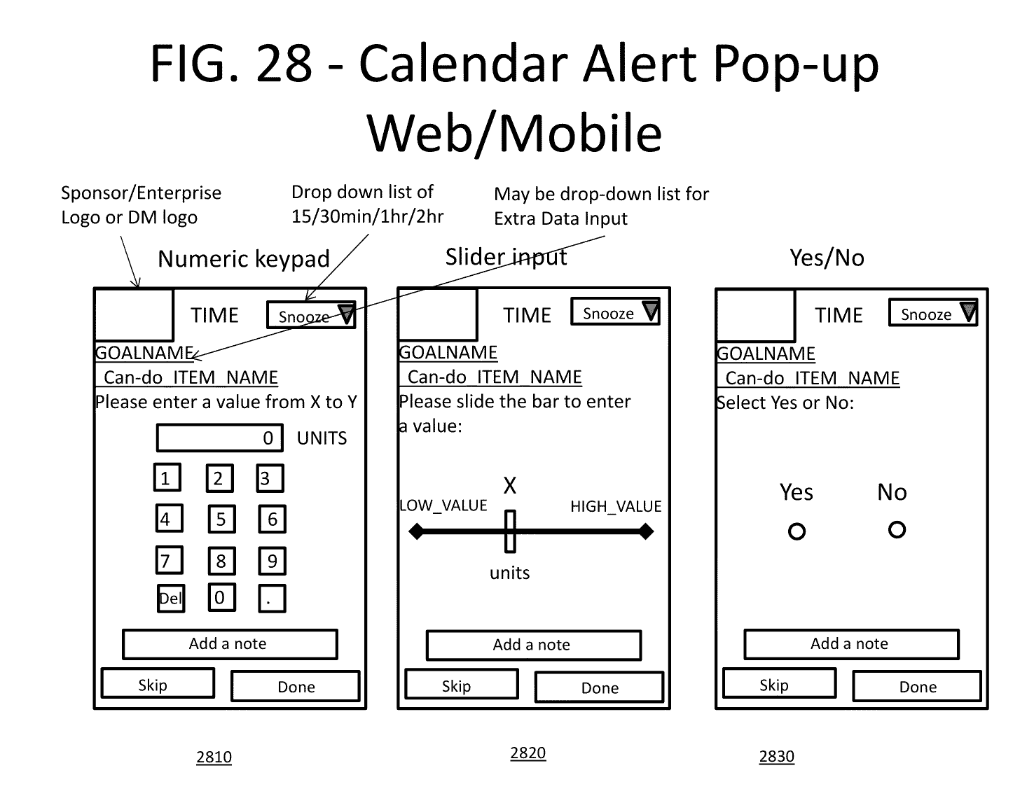

FIG. 28 depicts an exemplary interfaces 2810, 2820, and 2830 for entering information in accordance with one or more embodiments. A calendar alert is the time when a user must enter data related to a goal. The alert should look similar whether displayed on the web or a mobile device. Each should be pop-up windows that cover a portion of the original web page being viewed. The alert may include a Sponsor/Enterprise logo, that, if clicked, opens a new tab in browser to a new sponsor/enterprise user page. The current time may be displayed, e.g., in HH:MM AM|PM format. GOALNAME, name of the goal, may be displayed. Clicking on the GOALNAME may result in displaying a popup description of the goal and the GROUPNAME if the goal is part of a group, and a list of the Can-do items.

Can-do_ITEM_NAME, name of Can-do item, may be displayed. Clicking on Can-do_ITEM_NAME may result in displaying a popup description of Can-do item (see interface 2910) and its values/ranges. Snooze may provide a drop down list giving the user the option to snooze the alert for 15/30 min/1 hr/2 hr. The computer system 100 may, if the user logs off before alert re-appears, prompt user for input next login, if not >24 hours in the future (i.e., don't show snoozed alerts >24 hrs. old); may allow to snooze a max of 3 times; and if email/txt reminders enabled, they may occur every time the event occurs.

A +Context button may allow the user to Add Social/Mood/Place/other information related to that data point. Clicking a +Context button may display a pop-up frame (see Calendar Alert pop-up/+Context slide in interface 2920) to allow user to enter additional information. Skip may allow a user to skip data entry. If skipped, the computer system 100 may increment an alert counter, if set. Done may be selected. If the user has made any changes, the data for the Can-do item may be recorded; if no changes were made, the user may be prompted to make changes or Skip/Snooze. The computer system 100 may reset the alert counter if set; update Can-do item with date/time and value; and/or update DM points if sponsored action. Numeric keypad may allow a user to enter a value. The default value may be 0. Slider input may allow a user to enter a value using a slider. The default value may be half way between Scale: Low and High; X shows current value and track above slider bar; units stationary below bar in middle; increments depend on Low-high scale; bar movement in step increments depending on Scale entered during goal creation.

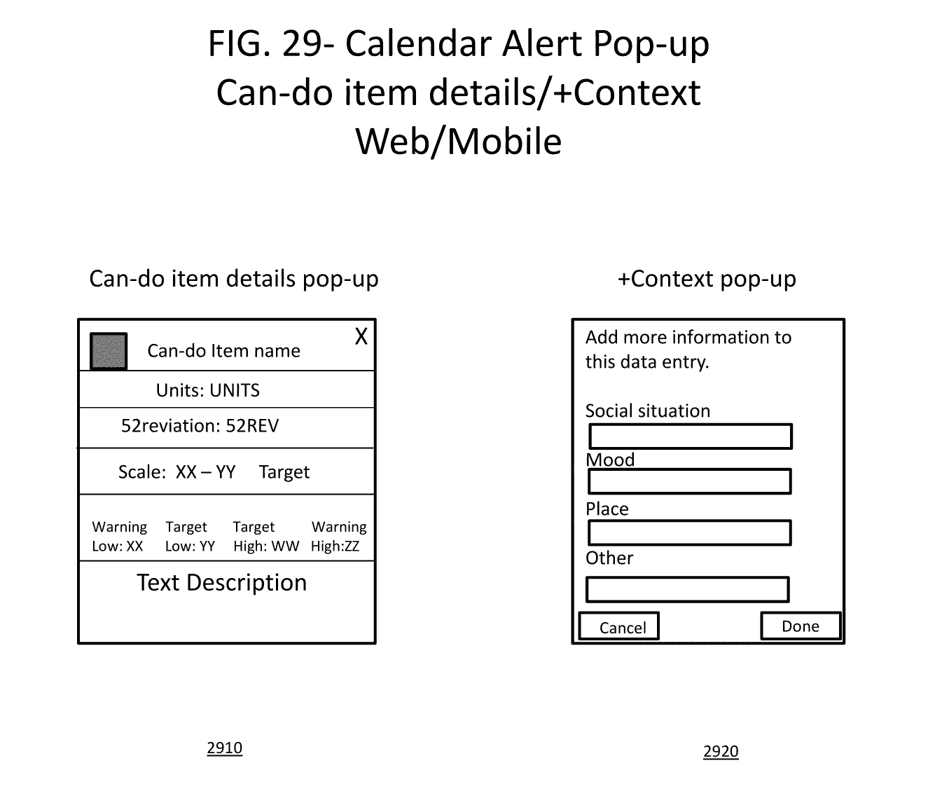

FIG. 29 depicts an exemplary interfaces 2910 and 2920 for entering information in accordance with one or more embodiments.

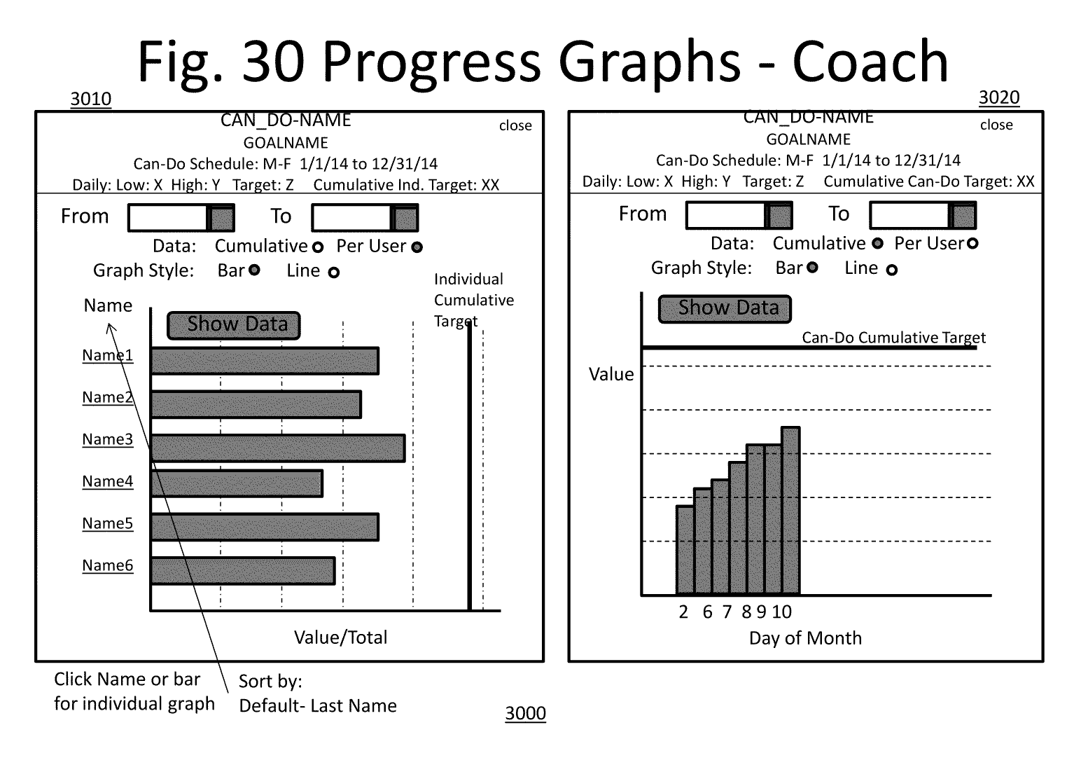

FIG. 30 depicts an exemplary interface 3000 for displaying a progress graph in accordance with one or more embodiments. A coach may view the progress on Can-Dos that make up a goal accessible interface 1500. The graph icon displayed next to the Can-Do name may be clicked to view a graphical status. The graph may contain a header describing the parameters of the Can-Do such as the schedule; daily Min/Max targets; Cumulative targets and date range for the displayed data or the life of the Can-Do. The default format may be line format, but other options such as a bar chart may be selected. The graph may be selected to show an individual view of each users current progress as shown in interface 3010. In this view, the coach may sort the display of data by user last name by clicking on the Y axis label, or they may sort the data base on Value by clicking on the X axis label. The graph may also have a line at a specific value which indicates the target value desired for each individual. There may be a Show Data button which when clicked will enable the user to see the data in a tabular text format, which may then be exported to a third party program. An export button on the page with a table of data may allow a user to choose the format for exporting data. As shown in interface 3020, a display can be generated with the Value on the Y axis and the X axis representing a Day of Month.

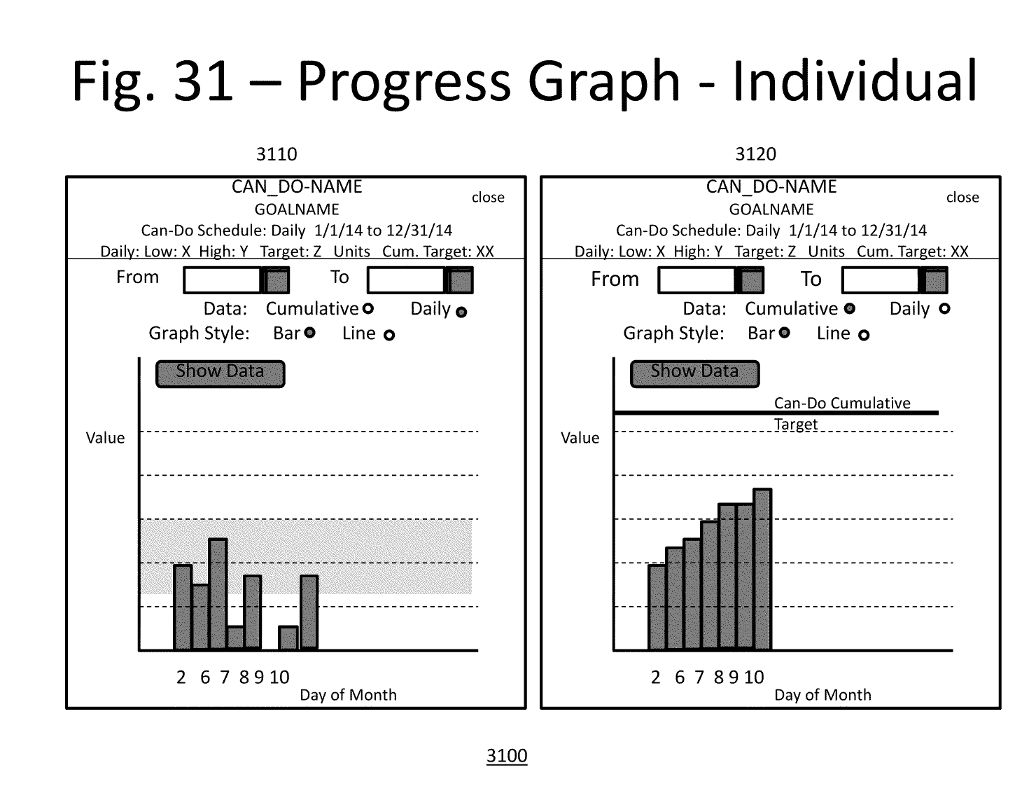

FIG. 31 depicts an exemplary interface 3100 for displaying a progress graph in accordance with one or more embodiments. A delightee/user may view the progress on Can-Dos that make up a goal accessible via interface 1700. The graph icon displayed next to the Can-Do name may be clicked to view a graphical status. The graph may contain a header describing the parameters of the Can-Do such as the schedule; daily Min/Max targets; Cumulative targets and date range for the displayed data or the life of the Can-Do. The default format may be line format, but other options such as a bar chart may be selected. The graph may be selected to show a daily view of progress as shown in interface 3110 and in order to give an accurate view, may only display dates on which the Can-Do activity was scheduled. The graph may also have a line at a specific value which indicates the target value desired for the Can-Do. There may be a Show Data button which when click will enable the user to see the data in a tabular text format, which may then be exported to a third party program. An export button on the page with a table of data may allow a user to choose the format for exporting data. An alternative format may be to display progress in a cumulative graph as shown in interface 3120. The graph may also have a line at a specific value which indicates the cumulative target value for the life of the Can-Do.

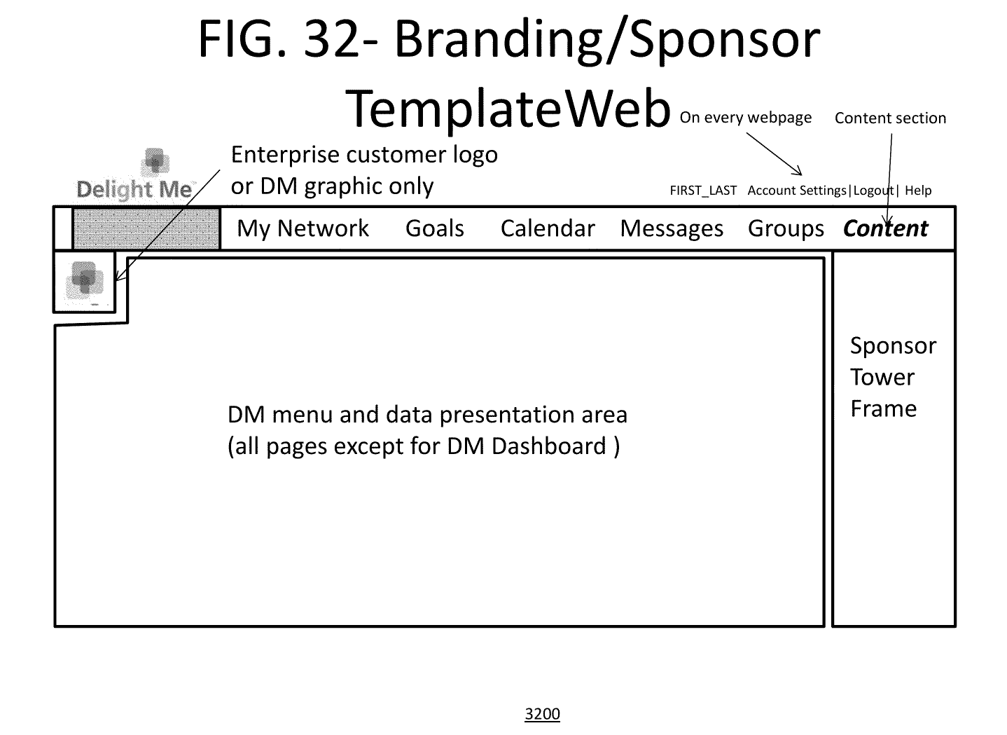

FIG. 32 depicts an exemplary interface 3200 for viewing a branding/sponsor template in accordance with one or more embodiments. Enterprise customer logo may be a clickable link to either DM website in a new page, or to a link chosen by the Enterprise customer. Sponsor Tower frame may be a location for sponsor advertising or enterprise messaging. FIRST_LAST may be the First and Last name of the logged in user. Help may provide context sensitive Help based on the current page. Content may link to a section for advertisers/sponsors to control placement of their ads and content. Content may refer to a main menu selection that will take the logged in user who is an advertiser on Delight Me® to a whole new section of the website made for advertising content providers. The advertising content providers may be able to setup when ads are shown and to who of the DM user base will be receiving information. The Content interface may be used to receive advertiser content provider selections, and may resemble an interface on Google Adwords®.

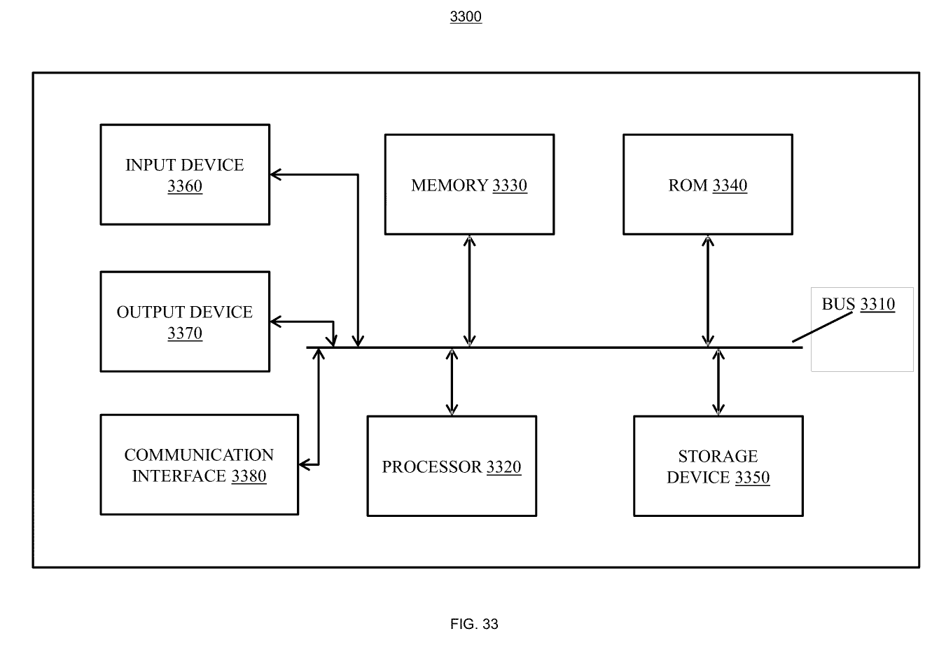

FIG. 33 depicts an exemplary architecture for implementing a computing device 3300 in accordance with one or more embodiments, which may be used to implement any of the device discussed herein, or any other computer system or computing device component thereof. It will be appreciated that other devices that can be used with the computing device 3300, such as a client or a server, may be similarly configured. As illustrated in FIG. 33, computing device 3300 may include a bus 3310, a processor 3320, a memory 3330, a read only memory (ROM) 3340, a storage device 3350, an input device 3360, an output device 3370, and a communication interface 3380.

Bus 3310 may include one or more interconnects that permit communication among the components of computing device 3300. Processor 3320 may include any type of processor, microprocessor, or processing logic that may interpret and execute instructions (e.g., a field programmable gate array (FPGA)). Processor 3320 may include a single device (e.g., a single core) and/or a group of devices (e.g., multi-core). Memory 3330 may include a random access memory (RAM) or another type of dynamic storage device that may store information and instructions for execution by processor 3320. Memory 3330 may also be used to store temporary variables or other intermediate information during execution of instructions by processor 3320.

ROM 3340 may include a ROM device and/or another type of static storage device that may store static information and instructions for processor 3320. Storage device 3350 may include a magnetic disk and/or optical disk and its corresponding drive for storing information and/or instructions. Storage device 3350 may include a single storage device or multiple storage devices, such as multiple storage devices operating in parallel. Moreover, storage device 3350 may reside locally on the computing device 3300 and/or may be remote with respect to a server and connected thereto via network and/or another type of connection, such as a dedicated link or channel.

Input device 3360 may include any mechanism or combination of mechanisms that permit an operator to input information to computing device 3300, such as a keyboard, a mouse, a touch sensitive display device, a microphone, a pen-based pointing device, wireless input device such as those that use Bluetooth and or infrared communication protocols, and/or a biometric input device, such as a voice recognition device and/or a finger print scanning device. Output device 3370 may include any mechanism or combination of mechanisms that outputs information to the operator, including a display, a printer, a speaker, etc.

Communication interface 3380 may include any transceiver-like mechanism that enables computing device 3300 to communicate with other devices and/or systems, such as a client, a server, a license manager, a vendor, etc. For example, communication interface 3380 may include one or more interfaces, such as a first interface coupled to a network and/or a second interface coupled to a license manager. Alternatively, communication interface 3380 may include other mechanisms (e.g., a wireless interface) for communicating via a network, such as a wireless network. In one implementation, communication interface 3380 may include logic to send code to a destination device, such as a target device that can include general purpose hardware (e.g., a personal computer form factor), dedicated hardware (e.g., a digital signal processing (DSP) device adapted to execute a compiled version of a model or a part of a model), etc.

Computing device 3300 may perform certain functions in response to processor 3320 executing software instructions contained in a computer-readable medium, such as memory 3330. In alternative embodiments, hardwired circuitry may be used in place of or in combination with software instructions to implement features consistent with principles of the disclosure. Thus, implementations consistent with principles of the disclosure are not limited to any specific combination of hardware circuitry and software.

Exemplary embodiments may be embodied in many different ways as a software component. For example, it may be a stand-alone software package, a combination of software packages, or it may be a software package incorporated as a “tool” in a larger software product. It may be downloadable from a network, for example, a website, as a stand-alone product or as an add-in package for installation in an existing software application. It may also be available as a client-server software application, or as a web-enabled software application. It may also be embodied as a software package installed on a hardware device.

Numerous specific details have been set forth to provide a thorough understanding of the embodiments. It will be understood, however, that the embodiments may be practiced without these specific details. In other instances, well-known operations, components and circuits have not been described in detail so as not to obscure the embodiments. It can be appreciated that the specific structural and functional details are representative and do not necessarily limit the scope of the embodiments.

It is worthy to note that any reference to “one embodiment” or “an embodiment” means that a particular feature, structure, or characteristic described in connection with the embodiment is included in at least one embodiment. The appearances of the phrase “in one embodiment” in the specification are not necessarily all referring to the same embodiment.

Although some embodiments may be illustrated and described as comprising exemplary functional components or modules performing various operations, it can be appreciated that such components or modules may be implemented by one or more hardware components, software components, and/or combination thereof. The functional components and/or modules may be implemented, for example, by logic (e.g., instructions, data, and/or code) to be executed by a logic device (e.g., processor). Such logic may be stored internally or externally to a logic device on one or more types of computer-readable storage media.

Some embodiments may comprise an article of manufacture. An article of manufacture may comprise a storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of storage media include hard drives, disk drives, solid state drives, and any other tangible storage media.

It also is to be appreciated that the described embodiments illustrate exemplary implementations, and that the functional components and/or modules may be implemented in various other ways which are consistent with the described embodiments. Furthermore, the operations performed by such components or modules may be combined and/or separated for a given implementation and may be performed by a greater number or fewer number of components or modules.

Some of the figures may include a flow diagram. Although such figures may include a particular logic flow, it can be appreciated that the logic flow merely provides an exemplary implementation of the general functionality. Further, the logic flow does not necessarily have to be executed in the order presented unless otherwise indicated. In addition, the logic flow may be implemented by a hardware element, a software element executed by a processor, or any combination thereof.

While various exemplary embodiments have been described above, it should be understood that they have been presented by way of example only, and not limitation. Thus, the breadth and scope of the present disclosure should not be limited by any of the above-described exemplary embodiments.

We claim:

1. A computer system including at least one processor for processing user-specified goal data for a plurality of user accounts, the computer system comprising:
a user-account storage unit that is configured to store a plurality of user account nodes, each user account node being configured to be directly linked to another of the plurality of user account nodes, and the linked user account nodes being configured using the at least one processor to form one of a plurality of relationships;
a goal-setting unit that is configured, for each user account node, (1) to receive at least one user-specified goal input from a user, a goal category input associated with the at least one user-specified goal, and at least one inputtable user-specified proposed accomplishment that relates to the user completing the respective goal, the user-specified proposed accomplishments having a value field that can be input by the user and a unit of measurement field that can be input by the user to a plurality of options, and (2) to store the at least one user-specified goal, the associated goal category and the at least one inputtable user-specified proposed accomplishment, as well as actual data related to achieving the proposed accomplishments, in a data storage unit, the goal-setting unit being configured to allow each user-specified goal of a user account node to select at least one of (a) a coach node and (b) at least one buddy node, from a predefined list of connections that are directly linked to the user account node, the selection of the at least one of the coach node and the at least one buddy node forming a relationship between the nodes;
a reminder-management unit that is configurable to assign user-specified reminders to each proposed accomplishment using the at least one processor, and to send predetermined reminders for the user-specified proposed accomplishments, the reminder-management unit being configured to send alerts at configurable time periods for a user-specified proposed accomplishment of the user account node when the user associated with the user account node has not satisfied the user-specified proposed accomplishment, and the reminder-management unit being configured to store periodic user-input associated with the user achieving the proposed accomplishment in the data storage unit;
a reward-management unit that includes a plurality of sponsor nodes with associated rewards for completing goals that the plurality of sponsor nodes offer, as well as respective requirements for obtaining the reward;
a messaging unit that is configured to accept input and send the input in a message from a sender user account node to at least one of a plurality of recipient user account nodes, the recipient user account nodes being in a relationship with the sender user account node, the messaging unit being configured to associate the message with one of the goals of the user account node; and
a display device that is configured to display (i) the user-specified goal data, (ii) progress graphs of user-specified goals for each user account node, and (iii) a status of obtaining a reward when a user-specified goal corresponds to one of the goals in the reward-management unit, the display device analyzing the actual value data of the data storage unit,
wherein the goal-setting unit is configured to associate each user-specified goal with the user account node or with another node or group of nodes that is in a relationship with the user account node, and
wherein the goal-setting unit is configured by the user to change one of a plurality of privacy settings in relation to the coach node and the buddy node, and to change one of a plurality of privacy settings in relation to the user-specified goals.

2. The computer system of claim 1, further comprising a group management unit that is configurable to assign a plurality of user account nodes to a group and is configurable to create member-specified group goals, wherein the group management unit is configured to allow each member of the group to add, edit and delete the member-specified group goals,
wherein the display device shows group progress of the member-specified group goals.

3. The computer system of claim 1, wherein the goal categories include sports, career, health, school, money, diet, world, hobbies and family.

4. The computer system of claim 1, wherein the goal categories are configured to be customizable.

5. The computer system of claim 1, further comprising an export unit that allows for a user to export the graph data.

6. The computer system of claim 1, further comprising an advertising unit that manages and displays advertising data for the user.

7. The computer system of claim 1, wherein the goal-setting unit is further configured to associate note attachment files to each proposed accomplishment that are visible to a coach node of the user account of the note attachment file, the note attachment file being in a format of a form document, an audio file or a video file.

8. The computer system of claim 1, wherein the data storage unit uses the actual value data for at least one of modeling, hypothesizing and predicting human behavior.

9. A computer-implemented method for processing user-specified goal data for a plurality of user accounts using at least one processor, the computer-implemented method comprising:
storing a plurality of user account nodes in a data storage unit, each user account node being configured to be directly linked to another of the plurality of user account nodes, and linked user account nodes being configured to form one of a plurality of relationships;
receiving for each user account node at least one user-specified goal input from a user, a goal category input associated with the at least one user-specified goal, and at least one inputtable user-specified proposed accomplishment that relates to the user completing the respective goal, the user-specified proposed accomplishments having a value field that can be input by the user and a unit of measurement field that can be input by the user to a plurality of options, whereby each user-specified goal of a user account node is configured to select at least one of (a) a coach node and (b) at least one buddy node, from a predefined list of connections that are directly linked to the user account node, the selection of the at least one of the coach node and the at least one buddy node forming a relationship between the nodes;
storing in the data storage unit the at least one user-specified goal with the associated goal category and the at least one inputtable user-specified proposed accomplishment, and the corresponding relationship between the nodes;
assigning user-specified reminders to each proposed accomplishment and send predetermined reminders for the user-specified proposed accomplishments;
sending alerts at configurable time periods for a user-specified proposed accomplishment of the user account node when the user associated with the user account node has not satisfied the user-specified proposed accomplishment;
providing a plurality of sponsor nodes with associated rewards for completing goals that the plurality of sponsor nodes offer, as well as respective requirements for obtaining the reward;
accepting input and sending the input in a message from a sender user account node to at least one of a plurality of recipient user account nodes based on predetermined user input, the recipient user account nodes being in a relationship with the sender user account node, the message being configured to associate with one of the goals of the user account node;
displaying on a display device (i) the user-specified goal data, (ii) progress graphs of user-specified goals for each user account node, and (iii) a status of obtaining a reward when a user-specified goal corresponds to one of the goals associated with the rewards;
associating each user-specified goal with the user account node or with another node or group of nodes that is in a relationship with the user account node; and
prompting the user to select for each user-specified goal one of a plurality of privacy settings in relation to the coach node and the buddy node, and to change one of a plurality of privacy settings in relation to the user-specified goals.

10. A non-transitory computer readable storage medium for processing user-specified goal data for a plurality of user accounts using at least one processor, the computer readable storage medium storing instructions that, when executed, cause a computer to perform steps comprising:
storing a plurality of user account nodes in a data storage unit, each user account node being configured to be directly linked to another of the plurality of user account nodes, and linked user account nodes being configured to form one of a plurality of relationships;
receiving for each user account node at least one user-specified goal input from a user, a goal category input associated with the at least one user-specified goal, and at least one inputtable user-specified proposed accomplishment that relates to the user completing the respective goal, the user-specified proposed accomplishments having a value field that can be input by the user and a unit of measurement field that can be input by the user to a plurality of options, whereby each user-specified goal of a user account node is configured to select at least one of (a) a coach node and (b) at least one buddy node, from a predefined list of connections that are directly linked to the user account node, the selection of the at least one of the coach node and the at least one buddy node forming a relationship between the nodes;
storing in the data storage unit the at least one user-specified goal with the associated goal category and the at least one inputtable user-specified proposed accomplishment, and the corresponding relationship between the nodes;
assigning user-specified reminders to each proposed accomplishment and send predetermined reminders for the user-specified proposed accomplishments;
sending alerts at configurable time periods for a user-specified proposed accomplishment of the user account node when the user associated with the user account node has not satisfied the user-specified proposed accomplishment;
providing a plurality of sponsor nodes with associated rewards for completing goals that the plurality of sponsor nodes offer, as well as respective requirements for obtaining the reward;
accepting input and sending the input in a message from a sender user account node to at least one of a plurality of recipient user account nodes based on predetermined user input, the recipient user account nodes being in a relationship with the sender user account node, the message being configured to associate with one of the goals of the user account node;
displaying on a display device (i) the user-specified goal data, (ii) progress graphs of user-specified goals for each user account node, and (iii) a status of obtaining a reward when a user-specified goal corresponds to one of the goals associated with the rewards;
associating each user-specified goal with the user account node or with another node or group of nodes that is in a relationship with the user account node; and
prompting the user to select for each user-specified goal one of a plurality of privacy settings in relation to the coach node and the buddy node, and to change one of a plurality of privacy settings in relation to the user-specified goals.
